(19) United States
(12) Patent Application Publication
(10) Pub. No.: US 2025/0139670 A1
(43) Pub. Date: May 1, 2025

(54) METHOD AND SYSTEM FOR PROCESSING DATA USING MACHINE LEARNING MODELS

(71) Applicant: ARGUS SOFTWARE, INC., Houston, TX (US)

(72) Inventors: Michael Jonathan Clawar, Durham, NC (US); Heidi Gabrielle Learner, Hoboken, NJ (US)

(21) Appl. No.: 18/498,732

(22) Filed: Oct. 31, 2023

(51) Int. Cl. G06Q 30/02

(52) U.S. Cl. CPC G06Q 30/0278

(57) ABSTRACT

A method for managing valuation of an asset includes: inferring, by an engine and using a trained model, a future rent and asset sale price (FRASP) value of an asset based on an inferencing dataset received from an analyzer; upon receiving the FRASP value, appending, by the analyzer, the FRASP value to the inferencing dataset to generate an inferred FRASP value output; generating, by the analyzer, an asset valuation value for the asset based on the FRASP value and a net present value (NPV) of a known cash flow; and initiating, by the analyzer, notification of an administrator about the asset valuation value for the asset using a graphical user interface (GUI).

### BACKGROUND

In the industry of commercial real estate (CRE, which is a feature that is used to generate profit or income), most industry professionals (e.g., debt brokers, individual investors, property managers, construction professionals, etc.) specialize around one or more asset (e.g., property, building, etc.) types. An “asset type” is a functional type of an asset (e.g., retail, industrial, an office, a land, etc.). Therefore, the asset type is one of the most important factors one may know about an asset, other than a location of that asset. Without the asset type, potential assets may not be discovered, and asset ownership portfolios and their owners may not be properly identified.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments of the invention.

FIG. 2 shows a diagram of an infrastructure node (IN) in accordance with one or more embodiments of the invention.

FIGS. 3.1 and 3.2 show a method for generating a future rent and asset sales price (FRASP) model in accordance with one or more embodiments of the invention.

FIG. 3.3 shows a method for inferencing using the FRASP model in accordance with one or more embodiments of the invention.

FIG. 4 shows an example augmented dataset in accordance with one or more embodiments of the invention.

FIG. 5 shows an example FRASP dataset in accordance with one or more embodiments of the invention.

FIG. 6 shows an example training dataset in accordance with one or more embodiments of the invention.

FIG. 7 shows an example valuation dataset in accordance with one or more embodiments of the invention.

FIG. 8 shows an example inferencing dataset in accordance with one or more embodiments of the invention.

FIG. 9 shows an example inferred reasonable FRASP value output dataset in accordance with one or more embodiments of the invention.

FIG. 10 shows an example final “asset” valuation value output dataset in accordance with one or more embodiments of the invention.

FIG. 11 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, valuation (or asset valuation) is considered as a core part of CRE. Reliably predicting a value of a real estate asset (e.g., a real property asset, a real asset, etc.) is essential for all parts of a real estate lifecycle, including but not limited to, capital raising, development, acquisition, portfolio management, disposition, etc. Today, current valuation approaches (e.g., the replacement cost approach, the comparable sales approach (or the “comps” approach), the comps with an embedded automated valuation model (AVM) approach, the discounted cash flow (DCF) approach, etc.) suffer from multiple drawbacks, for example: (i) including many assumptions that are based on human intuition, even when backed up with data (consequently, these approaches are relatively static over time or by market), (ii) requiring one or more manual processes (e.g., inputting lease information, gathering comparable leases, executing multiple models that all require manual effort, etc.) that results in labor costs representing a relatively high portion of the total cost of delivery, and/or (iii) getting affected by the condition of appraisals (e.g., appraisals are time-intensive and may reflect stale data, which may contribute to the appraisal's reputation as lagging known market conditions).

For example, in the replacement cost approach, a user may first estimate a land's value as if it was vacant based on current usage details (step 1). The user may then estimate replacement/reproduction cost of the corresponding asset (e.g., a hospital, a football arena, etc.) and required improvements (step 2), and may estimate accrued depreciation (step 3). Finally, the user may obtain the value of the asset based on ((step 1+step 2)-step 3). As yet another example, the comps approach may first find transaction values of assets that are comparable to the one being valued, and the corresponding appraiser may make any hedonic adjustments (e.g., using regression) for any unique characteristics related to the asset (e.g., location information (e.g., how does location desirability affect comparability?), market trends (e.g., how has the broader CRE market changed for sales?), comparable sales (e.g., what date range should be used for sales?), asset/building attributes (e.g., how does building age and renovations affect sales comparability?), etc.).

As yet another example, the comps with an embedded AVM approach is a statistical model-based approach compared to the comps approach. This approach may use comparable transactions that have occurred in the market and dependent on the quality of source data, but the adjustments may be made automatically by a model/algorithm rather than ad hoc by a user/human. As yet another example, the DCF approach may take known and assumed tenant CFs (or in-place CFs) (e.g., rental revenue at year 1, operating expenses at year 1, net operating income (NOI) at year 1, rental revenue at year 2, etc.) over the next 10 years and discount them back to today. The DCF approach may then add in a hypothetical sales price at the beginning of year 11 (which is known as the “reversion value”). However, the DCF approach necessitates a lot of assumptions (e.g., the reversion value is calculated by taking a year 11 NOI (which is assumed by considering an “assumed” terminal cap rate), rental revenue and/or operating expenses may need to be computed from in-place data or based on assumptions made by the user, etc.) that (i) are identical across assets and across time (which do not reflect reality because, for example, no differentiation across sub-markets based on current vacancy or demand is considered; there is no accounting for future supply (which may affect the renewal likelihood and time spent on the market); etc.) and (ii) are not based on actual history. For example, a typical assumption for an appraisal is that long-run annual market growth will be 3% everywhere and for all time.

In most cases where in-place leases drive substantially more of the value evaluation in office assets compared to the value evaluation in multifamily assets, a user may use the DCF approach. While using the DCF approach for the value evaluation of an office asset, the user may split CFs into three parts (e.g., to obtain the net present asset value) as, e.g.,: (i) in-place lease contribution to the value (23%) (e.g., the value from a 7-year contract), (ii) assumed lease contribution to the value (11%) (e.g., the value from CFs from potential renewals and/or new tenants), and (iii) reversion contribution to the value (66%) (e.g., the value from the future sale at an unknown price at the end of year 10), in which: (i)” represents an “actuals-driven value” and “(ii)-(iii)” show an “assumption-driven value”.

On the other hand, while using the DCF approach for the value evaluation of a multifamily asset, the user may split CFs into three parts as, e.g.,: (i) in-place lease contribution to the value (3%) (e.g., the value from a 1-year contract), (ii) assumed lease contribution to the value (31%), and (iii) reversion contribution to the value (66%). As indicated, the asset reversion value typically represents ⅔ of the net present asset value for the office asset and multifamily asset. The real difference comes from the contribution of known in-place leases (23% for the office asset and 3% for the multifamily asset). For example, assume that for an average stabilized multifamily asset, only the next 12 months' contractual rents are known. After 12 months, (i) a typical in-place rent increase for an existing tenant may occur or (ii) a new tenant may be contracted with a market renewal probability at the market rent. This means that (a) 90% (9 of the 10 years) of the CF-based value is from market conditions and 100% of the reversion contribution is from market conditions and (b) “in-place leases” only account for 3-4% (10%×30% CF contribution to the value=3%) of the value of the multifamily asset.

As yet another example, assume that for an average stabilized office asset, only the next 7 years contractual rents are known. After 7 years, (i) a typical in-place rent increase for an existing tenant may occur or (ii) a new tenant may be contracted with a market renewal probability at the market rent. This means that (a) 30% (3 of the 10 years) of the CF-based value is from market conditions and 100% of the reversion contribution is from market conditions and (b) “in-place leases” account for 20-25% (70%×30% CF contribution to the value=21%) of the value of the office asset.

So, if 3% of the value of the multifamily assets comes from in-place leases, it is almost 21% of the value of the office assets comes from in-place leases, and that is why the comps with embedded AVM approach (e.g., the comps-based AVM approach) works for multifamily assets (comparing to other more complicated property types) because market and/or location information may be used to estimate 96-97% of the actual asset value and very little information about in-place operations of the asset is required to get a good/fair estimate of the asset value (e.g., the typical lease term for multifamily assets is one year, meaning that in-place rental income for identical assets should only differ by a maximum of 12 months of rent). However, the comps-based AVM approach does not work for office, industrial, or retail assets because 20-25% of the value of the assets comes from CFs based on in-place leases that have almost nothing to do with the state of the market today (because they may have been signed many years in the past), which means a lot of information about the in-place leases/operations of the asset is required to get a good estimate of the asset value.

As indicated above, today's CRE valuation technology and methodology could not keep the pace with certain asset classes, and current AVMs (e.g., the comps-based AVM approaches) have failed because they focus on identifying assets with similar attributes to the target asset in as much as they suggest that similar assets should generate similar rental streams (e.g., current AVMs fails to account for the differences in CFs between two identical assets with different in-place leases (e.g., varying start dates, contract terms, etc.), and the upshot is that if those identical, physically adjacent assets have in-place tenants paying different rents with different lease expiries, the assets will not sell for the same price). Said another way, an AVM that is generated using a top-down approach (i.e., predicting an asset's value based on NOI and location only, without considering existing leases in-place) may work only for single family assets (with no leases), multifamily assets (with short term leases), and self-storage assets (with short term leases), but will not work for commercial assets (e.g., office, industrial, retail, etc.) with leases in-place.

Further, the current DCF approaches rely on several potentially flawed assumptions that must be made about “future” tenants and the associated CFs from these leases (e.g., an assumption regarding future rents and occupancy, an assumption regarding the likelihood that current tenants will renew their leases on expiry, an assumption regarding the pace of net absorption of vacant space, an assumption regarding the amount and timing of future tenant improvement allowances and free rent, an assumption regarding future asset expenses and property taxes, etc.). If a user adjusts the difference with respect to in-place CFs between two identical assets, the “adjusted” appraised value should be identical. The current DCF approaches have attempted to address the difference in rental streams across assets by appropriately accounting for the present value of “known” CFs. However, the shortcoming of the current DCF approaches rests in the number of inaccurate and/or non-historical/non-statistical assumptions that must be made about future tenants and the associated CFs from these leases.

For at least the reasons discussed above (e.g., the shortcomings of current appraisal and valuation approaches, which have been in the market for decades but still no real and useful implantation of such approaches has occurred) and without requiring resource (e.g., time, engineering, etc.) intensive efforts, a fundamentally different approach (e.g., the cash flow-adjusted comparables (CFAC) AVM approach, or shortly “the CFAC AVM approach”) is needed (e.g., a hybrid approach to appraisals that (i) does not need humans to make any explicit assumptions about future conditions and (ii) treats the known CFs and the remaining value of an asset separately and values them independently). Embodiments of the invention relate to methods and systems for the CFAC AVM approach (e.g., a machine-driven valuation approach as a Service), which is based on the concept of separating CFs into deterministic and stochastic (or “known” and “unknown”) components. In order to address the shortcomings of current appraisal and valuation approaches, the CFAC AVM approach acts as a combination of the DCF approach (or the “income-based” approach) and the comparables approach, and directly addresses their weaknesses.

In most cases, the DCF approach for valuation includes three types of CFs: (i) the value of known CFs from in-place tenants (e.g., known CFs are CFs (e.g., revenue, expenses, etc.) associated with contracted current or future/highly certain tenants (for example, an entity has a lease for an asset expiring in May 2030, which is known. This asset will either be occupied by the entity, by a new tenant with some probability, or vacant for some period of time with some probability. The revenue associated with the asset currently being leased by the entity to be known before May 2030 and unknown after May 2030)), (ii) the value of unknown CFs (from new tenants and/or renewing tenants) at a later point-in-time (e.g., unknown CFs are CFs that may occur in the future but are not currently contracted), and (iii) the unknown sales price of an asset at a later point-in-time (e.g., the reversion value). While only a “discount rate” is required to evaluate the present value of the known, in-place CFs, one or more assumptions may be needed to obtain a value conclusion.

Further, the DCF approach requires, at least, (i) an explicit statement of lease CFs, for example, over a 10-year horizon and (ii) an explicit statement of the corresponding asset's sales price at the end of year 10, both of which require one or more assumptions regarding the future conditions of the CRE market (e.g., what will future real property assets demand look like when current tenants vacate?, how will real property asset supply have changed?, how will the corresponding area have been affected by disinvestment?, what will the financial terms of any new leases (e.g., including assumptions about the creditworthiness of new tenants, lease length, incentives, etc.) look like, etc.).

A rent level of an asset at which future leases will be signed is one of the most critical assumptions one needs to make in the DCF approach-which is also among the most challenging to predict. In the DCF approach, regardless of the current (and/or potential future) economic environment, rents are always assumed to increase at a positive rate. The assumption of always constant and positive rental increase/growth (which may be used to determine future lease CFs when hypothetical tenants sign in the future and may also be used to derive the future sales price) is among the most flawed. The CFAC AVM approach eliminates the need for the aforementioned assumptions, many of which have no statistical basis. By grouping the unknown CFs (e.g., including CFs stemming from future tenants and proceeds from the hypothetical sales price (or the reversion value) at the end of year 10), a user may explicitly model asset- and location-level factors that explain a combined set of CFs based on the following: “transaction price today=present value (known CFs)+present value (unknown lease CFs)+present value (unknown sales price, for example, at year 10)”. In this manner, the CFAC AVM approach allows a user to make use of the above equations while eliminating assumptions that are unlikely to be true.

Further, in most cases, CRE represents a heterogonous framework, in which almost no two assets are alike—whether due to location, age, and/or amenity related differences and due to the make-up of current tenants (including how much current tenants are paying rent). As described above, two identical assets occupied by tenants that are paying two different rent amounts would not sell for the same price (e.g., as with the DCF approach, the value of in-place tenants and the CFs generated by those tenants may affect the sales price of the corresponding asset). To this end, a method that compares recent sales prices of “comparable” assets to any target asset (whether such similarity is due to asset characteristics and/or location of the asset) will be flawed because the comparables approach does not consider in-place CFs. Additionally, in smaller locales or in periods of reduced market liquidity, the number of comparable transactions may be small. Stale or older comparables may be used, but without adjusting changes in sales prices over time, causing any comparables approach to produce flawed asset value estimates.

The CFAC AVM approach addresses the flaws of the comparables approach by directly adjusting for differences in value due to different in-place tenant CFs. With the help of the framework provided by the CFAC AVM approach (e.g., the framework that incorporates a time fixed effect and a spatial regression component into the approach), a user may consider a wider set of comparables (e.g., a user may use older transactions as well as transactions not in the immediate vicinity of the target asset).

Embodiments of the invention relate to methods and systems to manage appraisal and valuation of real property assets. More specifically, in one or more embodiments, an orchestrator may first obtain an asset dataset (AD). After receiving the AD from the orchestrator, an analyzer may analyze the AD to generate a weighted average lease expiry (WALE) of a known lease and to generate an NPV of a known CF. The orchestrator may then obtain a sale transactions dataset (STD) and upon receiving the STD from the orchestrator, the analyzer may combine the NPV of the known CF, WALE of the known lease, and STD using a fingerprint to generate an augmented dataset (AD). The analyzer may obtain a FRASP value for a transaction based on the AD, in which the FRASP value for the transaction may be used to generate a FRASP dataset.

Thereafter, the orchestrator may obtain an economic and demographic dataset (EDD), a market dataset (MD), an asset characteristics dataset (ACD), and a location dataset (LD) and send those datasets to the analyzer. The analyzer may then combine the EDD, MD, ACD, and LD with the FRASP dataset to generate a training dataset (TD), in which the analyzer instructs an engine to generate a model that predicts FRASP values for transactions and sends the TD to the engine. After receiving the TD, the engine may generate a trained model by training the model based on the TD. The engine may then infer a FRASP value of a corresponding real property asset based on an inferencing dataset received from the analyzer. Upon receiving the FRASP value of the asset, the analyzer may append the FRASP value of the asset to the inferencing dataset to generate an inferred FRASP value output. The analyzer may then generate an asset valuation value for the asset based on the FRASP value of the asset and NPV of the known CF. Finally, the analyzer may initiate display of the asset valuation value for the asset on a graphical user interface (GUI).

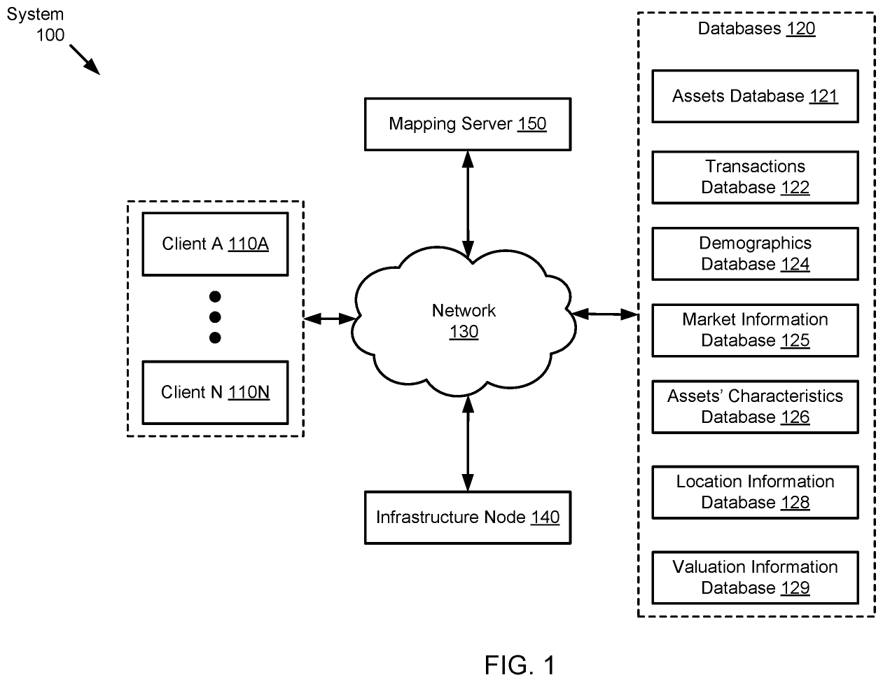

As a result of the processes discussed below, one or more embodiments of disclosed herein advantageously ensure that (on top of the aforementioned advantages of the CFAC AVM approach): (i) a more robust, unbiased, and scientific asset appraisal and valuation management is provided (e.g., for at least CF modeling (e.g., rent rolls, expenses, etc.), and pricing asset attributes and location information), (ii) advanced analytics-based measurement of real property assets (which are valued free and clear of debt, regardless of whether they have debt) is performed based on the most relevant datasets assembled/obtained from the corresponding databases (see FIG. 1), (iii) more data points are considered while evaluating the performance and/or risk management of the CFAC AVM approach (e.g., while deriving insight/intelligence regarding the impact of known asset and location characteristics on the CFAC AVM approach's robustness), (iv) making assumptions (only if necessary) regarding a discount rate for in-place CFs and expenses during weighted average lease term (WALT)/WALE that are not human driven (e.g., the CFAC AVM approach does not depend on nearly as many assumptions as the DCF approach or the comparables approach), (v) a scalable, faster (e.g., returning a result instantly (e.g., in milliseconds (ms)) after in-place leases and associated expenses are entered), automated, smarter, and cheaper asset appraisal and valuation approach (e.g., a bottom-up AVM approach that considers leases in-place and generates more consistency across appraisers) is provided for a better user experience (e.g., a typical internal appraisal may require 10 hours per asset per quarter on gathering market data for analysis, and 10 hours on lease and expense data entry and validation, which means every 1,000 appraisals then require 20,000 hours of resource-intensive effort and the CFAC AVM approach minimizes or eliminates this effort), (vi) the period of time spent on any one appraisal is reduced (e.g., the CFAC AVM approach reduces 10 hours per internal appraisal per quarter on subjective assumptions (e.g., 10,000 s of hours quarterly), the CFAC AVM approach reduces 10 hours per internal appraisal per quarter on factual data (e.g., 10,000 s of hours quarterly), etc.), and/or (vii) the CFAC AVM approach is enabled for implementation in other technical fields and/or for other purposes (e.g., underwriting (insurance or loans), acquisition price recommendations, comparable sales recommendation, market value modeling for tax purposes, enhancements to market forecasting models, etc.).

The following describes various embodiments of the invention.

FIG. 1 shows a diagram of a system (100) in accordance with one or more embodiments of the invention. The system (100) includes any number of clients (e.g., Client A (110A), Client B (110B), etc.), one or more databases (120), a network (130), an infrastructure node (IN) (140), and a mapping server (150). The system (100) may include additional, fewer, and/or different components without departing from the scope of the invention. Each component may be operably connected to any of the other components via any combination of wired and/or wireless connections. Each component illustrated in FIG. 1 is discussed below.

In one or more embodiments, the clients (e.g., 110A, 110B, etc.), the databases (120), the IN (140), and the mapping server (150) may be physical or logical devices, as discussed below. While FIG. 1 shows a specific configuration of the system (100), other configurations may be used without departing from the scope of the invention. For example, although the clients (e.g., 110A, 110B, etc.) and the IN (140) are shown to be operatively connected through a communication network (e.g., 130), the clients (e.g., 110A, 110B, etc.) and the IN (140) may be directly connected (e.g., without an intervening communication network). As yet another example, although the IN (140) and the mapping server (150) are shown to be operatively connected through a communication network (e.g., 130), the IN (140) and the mapping server (150) may be directly connected.

Further, the functioning of the clients (e.g., 110A, 110B, etc.) and the IN (140) is not dependent upon the functioning and/or existence of the other components (e.g., devices) in the system (100). Rather, the clients (e.g., 110A, 110B, etc.) and the IN (140) may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. Further, as used herein, the term “data” is intended to be broad in scope. In this manner, that term embraces, for example (but not limited to): data segments that are produced by data stream segmentation processes, data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the disclosure are not limited to any particular form of representing and storing data or other information. Rather, such principles are equally applicable to any object capable of representing information.

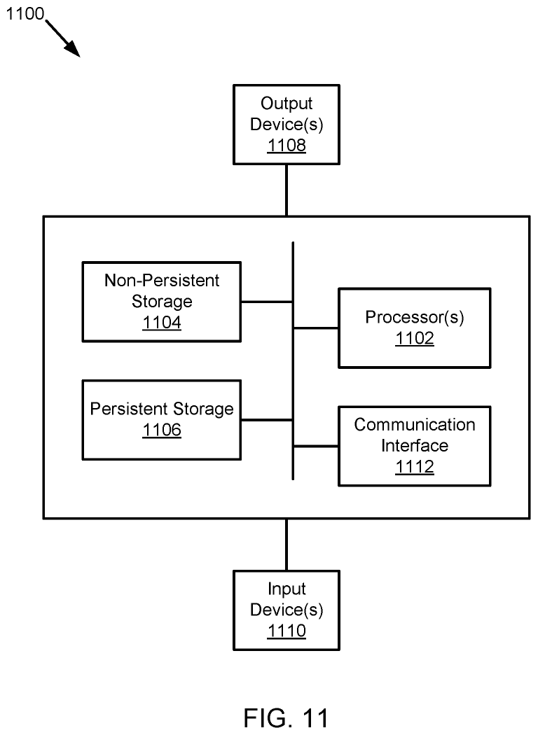

In one or more embodiments, the system (100) may represent a distributed system (e.g., a distributed computing environment, a cloud computing infrastructure, etc.) that delivers at least computing power (e.g., real-time network monitoring, server virtualization, etc.), storage capacity (e.g., data backup), and data protection (e.g., software-defined data protection, disaster recovery, etc.) as a service to users (e.g., end-users) of the clients (e.g., 110A, 110B, etc.). The system (100) may also represent a comprehensive middleware layer running on computing devices (e.g., 1100, FIG. 11) that supports virtualized application environments. In one or more embodiments, the system (100) may support a virtual machine (VM) environment, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide the aforementioned computer-implemented services to the users, the system (100) may perform some computations (e.g., data collection, distributed processing of collected data, etc.) locally (e.g., at the users' site using the clients (e.g., 110A, 110B, etc.)) and other computations remotely (e.g., away from the users' site using other environments (e.g., 140)) from the users. By doing so, the users may utilize different computing devices (e.g., 1100, FIG. 11) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, the IN (140) (e.g., an information handling system (IHS)) may include (i) a chassis configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

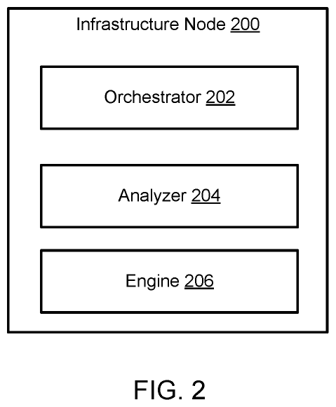

In one or more embodiments, as being a physical computing device or a logical computing device, the IN (140) may be configured for, e.g.,: (i) hosting and maintaining various workloads, (ii) providing a computing environment whereon workloads may be implemented, (iii) providing computer-implemented services to one or more entities, (iv) exchanging data with other components registered in/to the network (130) in order to, for example, participate in a collaborative workload placement (e.g., the IN (140) may split up a request (e.g., an operation, a task, an activity, etc.) with another IN in the system (100), coordinating its efforts to complete the request more efficiently than if the IN (140) had been responsible for completing the request), (v) operating as a standalone device, (vi) providing software-defined data protection for the clients (e.g., 110A, 110B, etc.), (vii) providing automated data discovery, protection, management, and recovery operations for the clients, (viii) providing data deduplication, (ix) orchestrating data protection through one or more GUIs, (x) empowering data owners (e.g., users of the clients) to perform self-service data backup and restore operations from their native applications, (xi) ensuring compliance and satisfy different types of service level objectives (SLOs) set by an administrator, (xii) simplifying VM image backups of a VM with near-zero impact on the VM, (xiii) increasing resiliency of an organization by enabling rapid recovery or cloud disaster recovery from cyber incidents, (xiv) providing long-term data retention (in conjunction with the databases (120)), (xv) providing operational simplicity, agility, and flexibility for physical, virtual, and cloud-native environments, (xvi) consolidating multiple data process or protection requests (received from, for example, the clients) so that duplicative operations (which may not be useful for restoration purposes) are not generated, and/or (xvii) initiating multiple data process or protection operations in parallel (e.g., an analyzer (e.g., 204, FIG. 2) may host multiple operations, in which each of the multiple operations may (a) manage the initiation of a respective operation and (b) operate concurrently to initiate multiple operations). In one or more embodiments, in order to read, write, or store data, the IN (140) may communicate with, for example, a storage array (not shown) and/or the databases (120).

As described above, the IN (140) may be capable of providing a range of functionalities/services to the users of the clients (e.g., 110A, 110B, etc.). However, not all of the users may be allowed to receive all of the services. To manage the services provided to the users of the clients, a system (e.g., a service manager) in accordance with embodiments of the invention may manage the operation of a network (e.g., 130), in which the clients are operably connected to the IN (140). Specifically, the service manager (i) may identify services to be provided by the IN (140) (for example, based on the number of users using the clients) and (ii) may limit communications of the clients to receive IN provided services.

For example, the priority (e.g., the user access level) of a user may be used to determine how to manage computing resources of the IN (140) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a user with a user access level/tier of 4/10). In such a scenario, the user level of that user may indicate that certain ports (of the subcomponents of the network (130) corresponding to communication protocols such as transmission control protocol (TCP), user datagram protocol (UDP), etc.) are to be opened, other ports are to be blocked/disabled so that (i) certain services are to be provided to the user by the IN (140) (e.g., while the computing resources of the IN (140) may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110B, etc.) may be granularly configured without modifying the operation(s) of the clients and (ii) the overhead for managing the services of the clients may be reduced by not requiring modification of the operation(s) of the clients directly.

In contrast, a second user may be determined to be a high-priority user (e.g., a user with a user access level of 9/10). In such a case, the user level of that user may indicate that more ports are to be opened than were for the first user so that (i) the IN (140) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, OS data, etc.), medium workloads with higher priority (e.g., VM with FS data, network data management protocol (NDMP) data, etc.), large workloads with critical priority (e.g., mission critical application data), etc.

Further, while a single IN (or IHS) is considered above, the term “system” includes any collection of systems or sub-systems that individually or jointly execute a set, or multiple sets, of instructions to provide one or more computer-implemented services. For example, a single IN may provide a computer-implemented service on its own (i.e., independently) while multiple other INs may provide a second computer-implemented service cooperatively (e.g., each of the multiple other information handling systems may provide similar and or different services that form the cooperatively provided service).

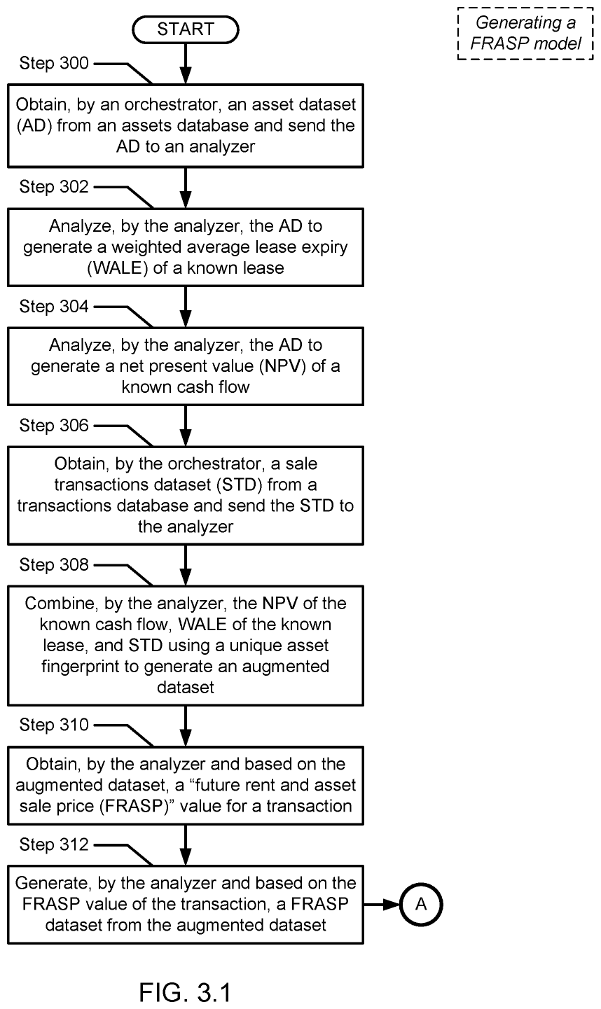

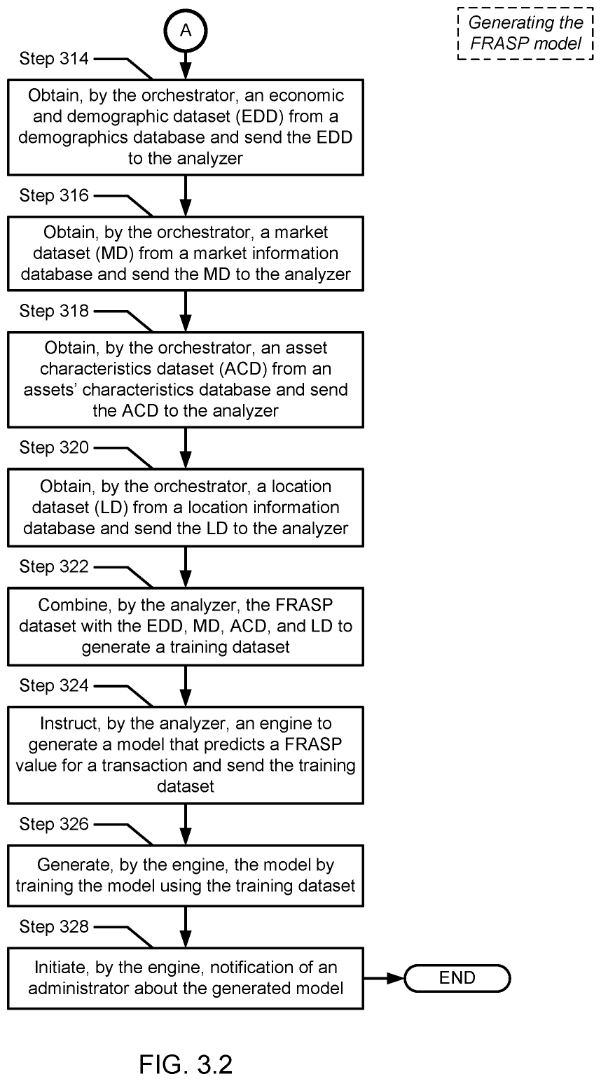

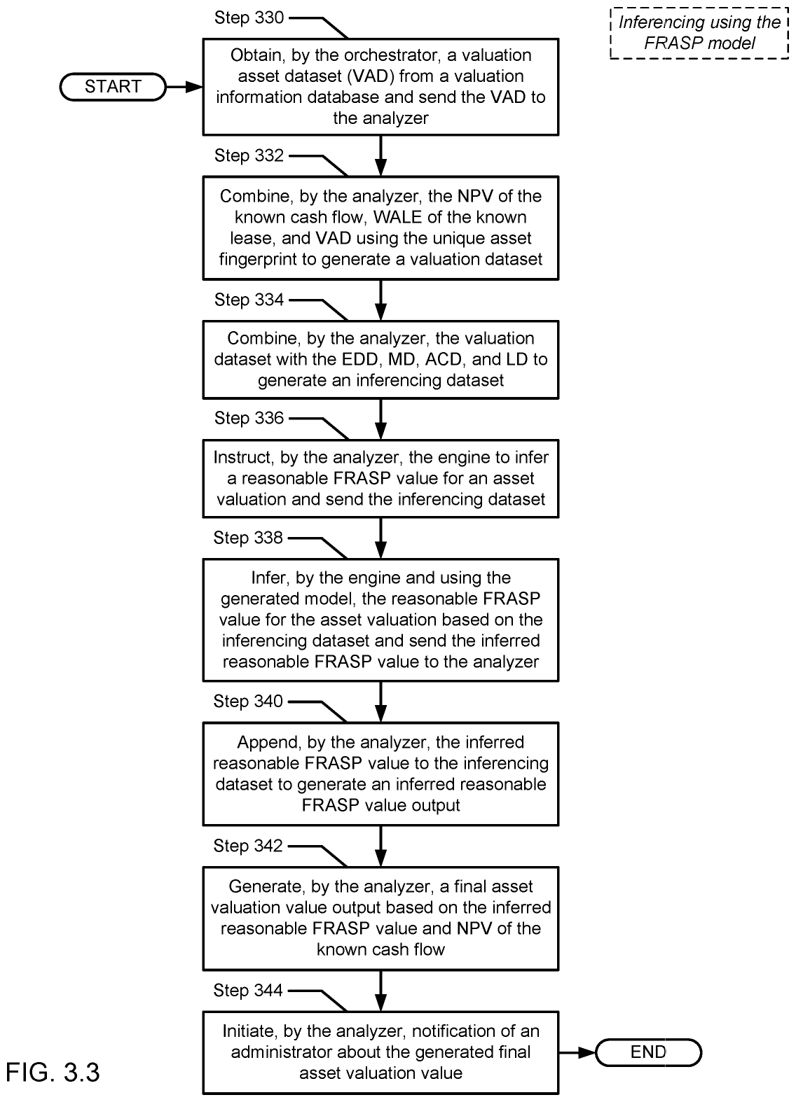

In one or more embodiments, the instructions may embody one or more of the methods or logic in FIGS. 3.1-3.3. In a particular embodiment, the instructions may reside completely, or at least partially, within a storage/memory resource (described below) of the IN (140) or another memory included in the IN, and/or within a processing resource (described below) of the IN (140) during execution by the IN.

In one or more embodiments, the IN (140) may provide computer-implemented services to users (and/or other computing devices such as, for example, other clients or other types of components). As described above, the IN (140) may provide any quantity and any type of computer-implemented services. To provide computer-implemented services, the IN (140) may include a collection of physical components (described below) configured to perform operations of the IN (140) and/or otherwise execute a collection of logical components (described below) of the IN (140).

In one or more embodiments, a processing resource (not shown) may refer to a measurable quantity of a processing-relevant resource type, which may be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a virtual CPU (vCPU), a virtual GPU (vGPU), a virtual DPU (vDPU), a computation acceleration resource, an application-specific integrated circuit (ASIC), a digital signal processor for facilitating high-speed communication, etc.

In one or more embodiments, a storage and/or memory resource (not shown) may refer to a measurable quantity of a storage/memory-relevant resource type, which can be requested, allocated, and consumed. A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, dynamic RAM (DRAM), etc.

In one or more embodiments, the IN (140) may include a memory management unit (MMU) (not shown), in which the MMU is configured to translate virtual addresses (e.g., those of a virtual address space (discussed below)) into physical addresses (e.g., those of memory). In one or more embodiments, the MMU may be operatively connected to the storage/memory resources, and the MMU may be the sole path to access the memory, as all data destined for the memory must first traverse the MMU prior to accessing the memory. Further, the MMU may be configured to: (i) provide memory protection (e.g., allowing only certain applications to access memory) and (ii) provide cache control and bus arbitration.

In one or more embodiments, while the IN (140) provide computer-implemented services to users, the IN (140) may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110B, etc.) may enter into agreements (e.g., service level agreements (SLAs)) with providers of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the invention.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface the IN (140) with external entities (e.g., the databases (120), the clients, etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., TCP, UDP, Remote Direct Memory Access (RDMA), IEEE 801.11, etc.) for the transmission and receipt of data.

In one or more embodiments, a networking resource may implement and/or support the above-mentioned protocols to enable the communication between the IN (140) and the external entities. For example, a networking resource may enable the IN (140) to be operatively connected, via Ethernet, using a TCP protocol to form a “network fabric”, and may enable the communication of data between the IN (140) and the external entities. In one or more embodiments, the IN (140) may be given a unique identifier (e.g., an Internet Protocol (IP) address) to be used when utilizing the above-mentioned protocols.

Further, a networking resource, when using a certain protocol or a variant thereof, may support streamlined access to storage/memory media of other entities in the system (100). For example, when utilizing RDMA technology to access data on a client (e.g., 110A), it may not be necessary to interact with the logical components of that client. Rather, when using RDMA technology, it may be possible for the networking resource to interact with the physical components of that client to retrieve and/or transmit data, thereby avoiding any higher level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual storage pool, etc. In one or more embodiments, a virtualization resource may include a hypervisor, in which the hypervisor may be configured to orchestrate an operation of, for example, a VM by allocating computing resources of the IN (140) to the VM.

In one or more embodiments, the IN (140) may implement a management model to manage the aforementioned computing resources in a particular manner. The management model may give rise to additional functionalities for the computing resources. For example, the management model may be automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and numbers of management models may be implemented to provide additional functionalities using the computing resources without departing from the scope of the invention.

Additional details of the IN are described below in reference to FIG. 2.

In one or more embodiments, the IN (140) may be implemented as a computing device (e.g., 1100, FIG. 11). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., HDDs, SSDs, etc.). The computing device may include instructions, stored in the persistent storage, that when executed by the processor(s) of the computing device cause the computing device to perform the functionality of the IN (140) described throughout this application.

Alternatively, in one or more embodiments, the IN (140) may be implemented as a logical device. The logical device may utilize the computing resources of any number of computing devices to provide the functionality of the IN (140) described throughout this application.

Turning now to the mapping server (150), the mapping server (150) may split up a request with another component of the system (100), coordinating its efforts to complete the request (e.g., to generate a response) more efficiently than if the mapping server (150) had been responsible for completing the request. In one or more embodiments, a request may be, for example (but not limited to): a web browser search request, a representational state transfer (REST) request, a computing request (e.g., a unique asset fingerprint generation request received from the IN (140)), a database management request, a registration request, a file upload/download request, etc.

To provide any computer-implemented services to one or more entities, the mapping server (150) may perform computations locally and/or remotely. By doing so, the mapping server (150) may utilize different computing devices that have different quantities of computing resources to provide a consistent experience to the entities. In one or more embodiments, the mapping server (150) may be a heterogeneous set, including different types of hardware components and/or different types of operating systems (OSs) (e.g., the mapping server (150) may have less, the same, or more computing resources (described above) comparing to the IN (140)).

In one or more embodiments, the mapping server (150) may include a production agent (not shown) that is configured to provide an asset resolution service (which identifies a unique asset fingerprint/identifier (ID) for an asset based on its address on a knowledge graph (KG)) and to generate a KG (e.g., based on records and/or data obtained from the databases (120), see below). Upon receiving, via an application programming interface (API) call, a user-entered address of an asset from an orchestrator (e.g., 202, FIG. 2) of the IN (140), the production agent may return the corresponding unique asset fingerprint of the asset to the orchestrator for further processing (see FIGS. 3.1-3.3). For example, the orchestrator may send “123 Target St, Maintown, Miami” to the production agent, and in return, may receive back a unique asset fingerprint for the parcel associated with this address.

As indicated, the production agent assigns (or “one-to-one” maps) each tax parcel, for example, in the United States a unique asset fingerprint. The fingerprint data and other data (e.g., entities, edges, vertices, etc.) relevant to a KG may be collected at the tax parcel level, meaning that the asset type and other history (or ownership) characteristics are collected at this level. The relationship between a tax parcel and its structures (e.g., assets, parking lots, etc.) may be one-to-one, one to many, or many to one.

In one or more embodiments, the production agent may identify (by employing a linear, non-linear, and/or machine learning (ML) model (e.g., a feature extraction model)) an asset type of an asset based on the information related to the asset (which may be obtained from the databases (120)), for example (but not limited to): the asset's owner and lender, the history of the asset, the tax valuation of the asset, details of the neighborhood, neighbor asset types (e.g., for each asset, asset types of k closest assets may be extracted by estimating a multinomial distribution over the asset types and because of the large scale of the data, the closest assets may be extracted using geohashing (where the production agent (i) may map each asset, using a latitude-longitude pair, to the asset's corresponding hash and (ii) may search for the closest assets to the same hash)), human population information, tenant information, the behavior of the asset type in the market and in the local region at different levels of granularity, an average number of total units, an average asset area, an average number of floors, an average market total value, an average tax amount, an average lot size per square foot, an average asset area per unit, an average floors per unit, an average market value per unit, an average tax per unit, an average lot size per unit, standard industrial classification (SIC) and North American industrial classification system (NAICS) codes for tenants, a legal description of the asset (e.g., the legal description may be used to extract words that are closely related to asset types and then estimate the probability of the asset to have an asset type including these words), zoning codes (including state and/or country information), a type of a point of interest (e.g., a coffee shop, a park, etc.) corresponds to the asset, a distance to the point of interest, a distance to a transportation system (e.g., a subway, a bus, a train station, etc.), extracted asset characteristics from satellite and street view images, assemblage data, etc. The aforementioned information may be obtained from the databases (120).

The identified asset type may allow an analyzer (e.g., 204, FIG. 2) (executing the CFAC AVM approach) to provide more potential opportunities for business revenue than they otherwise would have had available. For example, an asset type of an asset may be leveraged to infer an asset type of neighboring properties. Similarly, an asset type of a property may be leveraged to infer additional asset types of the same asset. An asset type of an asset may also be leveraged to infer asset types of other assets with the same owner or within the same complex.

As used herein, a “knowledge graph (KG)” represents an ontological structure (e.g., a method of entity and edge generation), including data. An ontology captures the data structures that make up a domain of knowledge. By capturing many contextual relationships within an ontological domain, the KG may aggregate data onto entities represented as vertices in a graph structure.

The production agent may execute a linear, non-linear, and/or ML model (e.g., an adaptive blocking model) that identifies one or more records from one or more data sources, which may contain information about an entity, or may contain information for an edge to connect entities. The objective of this model is to reduce the number of (possibly) grouped records. Information associated with the reduced number of grouped records may then be fed into a second linear, non-linear, and/or ML model (executed by the production agent) either to generate an edge between entities or to aggregate the identified records onto an entity. The second model may also provide a value/score (e.g., a degree of confidence) that indicates whether or not the information has been correctly identified and attributed to corresponding the KG in a correct structure.

In one or more embodiments, the production agent may then resolve one or more vertices from one or more record sources on the KG where each vertex of the vertices represents one or more records that contain information about an entity. The resolving of the vertices may include, e.g.,: (i) collecting relevant information pertaining to an entity type from record sources and (ii) reducing a possible number of records that are represented by each of the vertices (e.g., to perform “(ii)”, the production agent may execute an adaptive blocking model, in which the model may be iterated over until the number of records is reduced below a predetermined value). Further, the production agent may resolve one or more edges that contain a connection between two vertices, in which the resolving of the edges may include reducing a possible number of edges that are connected to each vertex to lower computational cost (e.g., to perform the reducing, the production agent may execute an adaptive blocking model, in which the model may be iterated over until the number of edges is reduced below a predetermined value).

In one or more embodiments, various types of entities may be resolved (from relevant data (e.g., entity types) available in the databases (120)) by the process for producing a KG. An entity may represent (or may be) an entity type, for example (but not limited to): an individual, an organization, a family, a team, a corporation, a charity, a real property asset, a locality, a government, a mortgage event, a sales event, etc. Entities may be connected in various ways such as through ownership interest, contracts, employment, lawsuits or other disputes, legal jurisdiction, and the like. Further, each edge may represent an edge type that is based on the vertices for which the edge is connected.

In one or more embodiments, the production agent may execute a third linear, non-linear, and/or ML model to: (i) generate a score that represents a degree of confidence in a resolution of the vertex, (ii) generate a score that represents a degree of confidence in a resolution of the edge, (iii) identify duplicate vertices based on resolved vertices and edges, and/or (iv) resolve vertices that were under-resolved.

In one or more embodiments, the production agent may implement a KG to efficiently organize large and complex data into a format of interconnected entities (e.g., entities that are connected by edges that represents relationships/associations between the entities), and may present the KG (once the vertices and edges of the KG are in place) in various formats to the corresponding client (where the client may the display the KG to a user on its GUI). For example, the GUI may display vertices of assets included in the KG (in various formats) as points on a map that correspond to the addresses of the assets (where (i) the positions of vertices are determined by one or more records of the entities for which the vertices represent and (ii) the vertices are positioned on a map relative to their respective asset addresses on the map).

As yet another example, a KG may be used to display real property assets (including a unique asset fingerprint of each asset based on the asset's geographic location (e.g., a latitude-longitude pair) within a specific regions, e.g., in the United States) on a map with connections to individuals and companies. A user may select an asset that represents features at its geographic location to open a record that identifies one or more individuals and/or organizations that have had legal interests in the asset, in which the asset may have connections to other assets based on records associated with the asset.

As described above, the production agent may perform a process for treating one or more sets of data (with a multitude of records) to resolve entities that are incorporated within the sets of data. The production agent may execute/employ one or more models that eliminate unrelated records to decrease the number of possible records corresponding to each entity. After the number of possible records is reduced, one of the models may process the remaining records to fully resolve the entities (e.g., entities may be resolved by determining associations of data between the entities).

Once the entities are resolved, one of the models (employed by the production agent) may determine one or more connections between entities to resolve an edge (if any) between the entities. All “pairs” of entities may be regarded as having possible edges. The production agent may employ a model (e.g., the adaptive blocking model) to reduce the number of possible connections by eliminating pairs of entities. In one or more embodiments, the adaptive blocking model assembles pairs into blocks based on parameters of the pairs of entities, in which the pairs that are not within the same block may not be considered. After reducing the number of pairs of entities to a manageable number, the production agent may evaluate the remaining pairs of entities to determine connections between the entities (e.g., a connection may be a legal interest between entities).

In one or more embodiments, the production agent may process each of the databases (120) to incorporate them into a KG. The production agent may inspect records that are stored in the databases (120) to resolve entities from the records (upon obtaining the records, if necessary, the production agent may convert various records into a similar format for a consistent processing). Once resolved, the entities may be linked through associations between the entities. As used herein, an association between entities may be any recorded connection of one entity to another entity. For example, an entity that represents an individual may be connected to an entity that represents an asset that was owned by the individual at a point-in-time. The same entity that represents the individual may be connected to another entity that represents a corporation for which the individual owned a controlling interest. The corporate entity may be connected to various other entities if the records in the databases (120) so indicate.

In one or more embodiments, the production agent may resolve entities by employing various models (e.g., the support vector machine (SVM) learning model, the decision tree model, the gradient boosted tree model, etc.) that determine whether records (and/or data) refer to the same entity. The various records may refer to the same, for example (but not limited to): names, phone numbers, addresses, emails, geographic regions, industry descriptions, etc. For example, one of the models may determine whether names that are close, but not the same, refer to the same entities. In this exemplary embodiment, the model may be, for example (but not limited to): the string similarity model, the Jaro-Winkler model, the Levenshtein distance model, etc.

A degree to which records refer to the same entity may be represented by a confidence score, which may be determined by another model (e.g., the random forest model, the k-nearest neighbors (KNN) model, etc.) employed by the production agent. The confidence score may be incorporated into the entity or connections between entities. Records that are similar beyond a predetermined threshold value may be determined to refer to the same entity. In one or more embodiments, records that belong to a specific entity may be ordered/prioritized, for example, according to their confidence score, monetary value, geographic proximity, and/or date of relevance where a more recent record date may be ordered ahead of the older dates.

In one or more embodiments, the production agent may collect/receive entities to be analyzed from a database, in which the entities may each be associated with one or more records. In order to infer connections between the entities (which may be represented as edges between vertices on the corresponding KG), the production agent may analyze pairs of records of the entities to determine if the records of one entity refer to another entity. If there is a possible edge for every combination of one type of entity with another type of entity, the total number of possible combinations may be high (e.g., for “N” number of property entities and “M” number of company entities, there are N×M possible combinations of an edge between the property and company entities). To this end, the production agent may employ the adaptive blocking model to reduce the number of pairs to be analyzed (based on, for example, a geographic region, a zip code, an organization type, etc.).

In one or more embodiments, the production agent may also include functionality to, e.g.,: (i) generate assemblages of asset parcels (e.g., assembled collective assets) based on descriptions of parcels (by employing an assemblage model, the production agent may detect which “adjacent” parcels are acting collectively as “one asset”, in order to have a better definition of a tax parcel for ownership purposes); (ii) analyze asset/parcel descriptions (asset data such as tax parcel records available from government or other organizations) of the corresponding assets (in a region) and determine a shape of one or more assets based on the descriptions; (iii) determine a spatial relationship between pairs of assets based on determined shapes of the assets; (iv) based on the spatial relationship determined in (iii), determine (a) whether or not the asset descriptions are a part of the same asset, (b) whether or not two assets should be merged (e.g., when assets share at least one common owner, the assets may be merged), and (c) whether or not there is a common owner (e.g., the determination may be performed iteratively for assets in a particular region); (v) determine whether or not pairs of assets (in a particular region) have the same owner (e.g., only assets with a close spatial relationship and the same owner may be part of the same asset); (vi) consider spatial relationships between pairs of assets while generating a KG; and/or (vii) assemble collective assets (i.e., assemblages) from multiple asset data descriptions. In one or more embodiments, a close spatial relationship may include an adjacent asset or may include one asset including another asset.

As used herein, a common/joint owner includes a list of all individuals and/or entities that share an ownership interest in an asset. The term “common owner” is not limited to joint tenants with a right of survivorship, but is intended to include all forms of shared ownership including, for example (but not limited to): limited liability companies (LLC's), sole proprietorships, partnerships, subsidiaries, parent companies, etc.

In one or more embodiments, an asset may be paired based on a spatial relationship with another asset. The spatial relationship may include, for example (but not limited to): sharing a boundary, having boundaries within a maximum distance of each other, having overlapping boundaries, having a boundary of an asset within the boundaries of another asset, sharing the same boundaries, etc. The production agent may process pairs of assets (that have a spatial relationship) to determine whether they are a collective asset. In one or more embodiments, a spatial relationship may be an arrangement of assets in a geographic region and may be used to determine whether any pair of assets are close enough in proximity to be used as a collective asset.

In one or more embodiments, the production agent may be implemented using hardware, software, or any combination thereof.

While the mapping server (150) has been illustrated and described as including a limited number of specific components, the mapping server (150) may include additional, fewer, and/or different components without departing from the scope of the invention. One of ordinary skill will appreciate that the mapping server (150) may perform other functionalities without departing from the scope of the invention.

In one or more embodiments, the mapping server (150) may be implemented as a computing device (e.g., 1100, FIG. 11). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., HDDs, SSDs, etc.). The computing device may include instructions, stored in the persistent storage, that when executed by the processor(s) of the computing device cause the computing device to perform the functionality of the mapping sever (150) described throughout this application.

Alternatively, in one or more embodiments, similar to the IN (140), the mapping server (150) may also be implemented as a logical device.

In the embodiments described above, the mapping server (150) is demonstrated as a separate entity from the IN (140); however, embodiments herein are not limited as such. The mapping server (150) may be a part of the IN (140).

In one or more embodiments, in order to provide their functionalities, the IN (140) and the mapping server (150) may need to communicate with other components of the system (100) with minimum amount of latency (e.g., with high-throughput (e.g., a high data transfer rate) and sub-ms latency). For this reason, REST application programming interfaces (REST APIs) may be used to enable communication(s) among the IN (140), the mapping server (150), and the other components.

In one or more embodiments, the databases (120) may include, at least, an assets database (121), a transactions database (122), a demographics database (124), a market information database (125), an assets' characteristics database (126), a location information database (128), and a valuation information database (129). A database (e.g., 121, 122, etc.) of the databases (120) may be a fully managed cloud (or local) database (or any logical container) that acts as a shared storage and/or memory (simply “storage/memory”) resource that is functional to store unstructured and/or structured data (e.g., each database may have dissimilar types of data/records and store the data in different formats). Further, the database may also occupy a portion of a physical storage/memory device or, alternatively, may span across multiple physical storage/memory devices.

In one or more embodiments, a database of the databases (120) may be implemented using physical devices that provide data storage services (e.g., storing data and providing copies of previously stored data). The devices that provide data storage services may include hardware devices and/or logical devices. For example, the database may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database may include a memory device (e.g., a dual in-line memory device), in which data is stored and from which copies of previously stored data are provided. As yet another example, the database may include a persistent storage device (e.g., an SSD), in which data is stored and from which copies of previously stored data is provided. As yet another example, the database may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, a database of the databases (120) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the assets database (121) may store/log/record (temporarily or permanently) unstructured and/or structured data (associated with one or more assets) that may include (or specify), for example (but not limited to): in-place leases, in-place rent rolls (including all contract terms such as step-ups, expiry, renewal options, tenant improvements, free rent, etc.), known operating expenses (e.g., Organization D has a contracted lease for 10 k square feet in an office asset and the asset owner knows with high-confidence that the 10 k square feet requires a contact with a janitorial vendor for $1 k/month, which is a known operating expense; a landscaping fee; a pes control fee; a utility fee; an insurance fee; etc.), known capital expenditures (e.g., an asset owner has a capital expenditure plan in place that is actively being rolled out to renovate two floors of its office asset and replace plumbing, flooring, and walls, in which the plan has a known budget and timeline for outlays from the owner and this would be considered as a known capital expenditure; a fee to replace an asset's roof; a fee to replace an asset-wide air conditioning system; a fee to implement a newer asset automation system; etc.), county asset tax records (which may be available from government or other organizations), parcel records, etc. Based on the aforementioned data, for example, the IN (140) (in conjunction with the mapping server (150)) may perform asset analytics to infer profiles of assets available in a specific region/location.

In one or more embodiments, the transactions database (122) may store/log/record (temporarily or permanently) unstructured and/or structured data (associated with one or more assets) that may include (or specify), for example (but not limited to): location information, a type of a sale event (e.g., a full or partial sale event), a price of a sale event, a close date of an asset, a recorded date of an asset, etc. Based on the aforementioned data, for example, the IN (140) (in conjunction with the mapping server (150)) may perform user/tenant analytics to infer profiles of existing users in a specific region.

In one or more embodiments, the demographics database (124) may store/log/record (temporarily or permanently) unstructured and/or structured data (associated with one or more assets) that may include (or specify), for example (but not limited to): population information, income information, employment information, a migration pattern, etc. Based on the aforementioned data, for example, the IN (140) (in conjunction with the mapping server (150)) may perform user analytics to infer profiles of existing users in a specific region.

As used herein, income may refer to all revenue (rental or otherwise) such as, for example, revenue generated by an asset less expenses associated with the asset (excluding interest payments for debt).

In one or more embodiments, the market information database (125) may store/log/record (temporarily or permanently) unstructured and/or structured data (associated with one or more assets) that may include (or specify), for example (but not limited to): existing “asset” supply information, vacancy information, supply net absorption (e.g., if 100 k square feet of space has been vacated by departing tenants in an asset during May, but 50 k square feet of space has been taken up by new tenants moving in, then the net absorption will be −50 k square feet), asking rent information (e.g., a list price of an asset for rent), new supply pipeline (e.g., new supply pipeline refers to new space (which may be occupied by a renter or an owner) that would impact the market dynamics for an existing asset, in which the new space may be generated by (i) new assets being constructed, (ii) renovations of existing assets to convert previously non-competitive space to a competitive space (for example, if the IN (140) is evaluating a multifamily apartment asset, an office asset nearby converted to apartments would be competitive space), and/or (iii) additions to existing assets to add an area, etc.), etc. Based on the aforementioned data, for example, the IN (140) may perform CRE market analytics to infer latest trends and/or profiles of assets in a specific region.

In one or more embodiments, the assets' characteristics database (126) may store/log/record (temporarily or permanently) unstructured and/or structured data (associated with one or more assets) that may include (or specify), for example (but not limited to): an age of an asset, building quality of an asset, a size of an asset (e.g., a number of stories, a number of elevators, an amount of square footage, an amount of outdoor space, etc.), a size of a lot (e.g., a lot size depth in feet, a lot size frontage in feet, etc.), a description of an asset (which may be defined based on a geographic location of the asset), an attribute of an asset (e.g., amenities provided by an asset, renovations required for the asset, the market value for renovations, the market value of the land, the sum of commercial units, the sum of residential units, the year the asset was built, the sum of full baths, the sum of half baths, a number of rooms, the longitude and latitude of the asset, the number of tenants, the tenants per asset area, etc.), a type of an asset (e.g., retail, industrial, office, multifamily, hospitality, public and semi-public, agricultural, easements/other, special purpose, tax exempt, vacant land, no asset type (if enough asset type information is not available), etc.), asset and land characteristics form image data, etc. Based on the aforementioned data, for example, the IN (140) (in conjunction with the mapping server (150)) may perform asset analytics to infer characteristics of the corresponding asset(s).

In one or more embodiments, the location information database (128) may store/log/record (temporarily or permanently) unstructured and/or structured data (associated with one or more assets) that may include (or specify), for example (but not limited to): points of interest nearby (e.g., a coffee shop, a park, etc.), zoning codes (including state and/or country information), a distance to a transportation system (e.g., a subway, a bus, a train station, etc.), transit times information, etc. Based on the aforementioned data, for example, the IN (140) (in conjunction with the mapping server (150)) may perform location analytics to infer profiles of existing users/tenants and environment in a specific region (e.g., a high-end tenant (e.g., an executive, an attorney, etc.) that lives in an environment that requires minimum capital expenditures and includes well-kept playgrounds for kids).

In one or more embodiments, the valuation information database (129) may store/log/record (temporarily or permanently) unstructured and/or structured data (associated with one or more assets) that may include (or specify), for example (but not limited to): location information of an asset, asset information regarding valuation “as of” date, etc. Based on the aforementioned data, for example, the IN (140) (in conjunction with the mapping server (150)) may perform valuation analytics to infer profiles of existing users and environment in a specific region.

In one or more embodiments, the unstructured and/or structured data may be updated (automatically) by third party systems (e.g., platforms, marketplaces, etc.) (provided by vendors) or by administrators based on, for example, newer (e.g., updated) attributes (of an asset) being available. The unstructured and/or structured data may also be updated when, for example (but not limited to): there is a change in population information, there is change in income information, etc.

In one or more embodiments, a database of the databases (120) may provide an indexing service. For example, an agent (not shown) of the database may receive various model training related inputs directly (or indirectly) from the IN (140). Upon receiving, the agent may analyze those inputs to generate an index(es) (e.g., a training process index(es)) for optimizing the performance of the database by reducing a required amount of database access(es) when implementing a request (e.g., a data retrieval request received from the IN (140)). In this manner, requested data may be quickly located and accessed from the database using an index of the requested data. In one or more embodiments, an index may refer to a database structure that is defined by one or more field expressions. A field expression may be a single field name such as “user_number”. For example, an index (e.g., E41295) may be associated with “user_name” (e.g., Adam Smith) and “user_number” (e.g., 012345), in which the requested data is “Adam Smith 012345”.

In one or more embodiments, the unstructured and/or structured data may be maintained by, for example, the IN (140) and/or an administrator of the IN (140). The IN (140) and/or the administrator may add, remove, and/or modify those data in the databases (120) to cause the information included in the databases (120) to reflect the latest version of, for example, income information. The unstructured and/or structured data available in the databases (120) may be implemented using, for example, lists, tables, unstructured data, structured data, etc. While described as being stored locally, the unstructured and/or structured data may be stored remotely, and may be distributed across any number of devices without departing from the scope of the invention.

While a database of the databases (120) has been illustrated and described as including a limited number and type of data, the database may store additional, less, and/or different data without departing from the scope of the invention. One of ordinary skill will appreciate that the database may perform other functionalities without departing from the scope of the invention. When providing its functionalities, the database may perform all, or a portion, of the methods illustrated in FIGS. 3.1-3.3. The database may be implemented using hardware, software, or any combination thereof.

In one or more embodiments, a client (e.g., 110A, 110B, etc.) may be a physical or logical computing device configured for hosting one or more workloads, or for providing a computing environment whereon workloads may be implemented. The client may correspond to a computing device that one or more users use to interact with one or more components of the system (100).

In one or more embodiments, different clients (e.g., 110A, 110B, etc.) may have different computational capabilities. For example, Client A (110A) may have 16 gigabytes (GB) of DRAM and 1 CPU with 12 cores, whereas Client N (110N) may have 8 GB of PMEM and 1 CPU with 16 cores. Other different computational capabilities of the clients (e.g., 110A, 110B, etc.) not listed above may also be taken into account without departing from the scope of the invention.

In one or more embodiments, a client (e.g., 110A, 110B, etc.) may include any number of applications (and/or content accessible through the applications) that provide computer-implemented application services to a user. Applications may be designed and configured to perform one or more functions instantiated by a user of the client. Examples of an application may include (but not limited to): a word processor, a media player, a web browser, a file viewer, an image editor, etc.

In order to provide application services, each application may host similar or different components. The components may be, for example (but not limited to): instances of databases, instances of email servers, etc. Applications may be executed on one or more clients as instances of the application.

In one or more embodiments, applications may vary in different embodiments, but in certain embodiments, applications may be custom developed or commercial applications that a user desires to execute in a client (e.g., 110A, 110B, etc.). In one or more embodiments, applications may be logical entities executed using computing resources of a client (e.g., 110A, 110B, etc.). For example, applications may be implemented as computer instructions, e.g., computer code, stored on persistent storage of the client that when executed by the processor(s) of the client cause the client to provide the functionality of the applications described throughout the application.

In one or more embodiments, while performing, for example, one or more operations requested by a user, applications installed on a client (e.g., 110A, 110B, etc.) may include functionality to request and use physical and logical components/resources of the client. Applications may also include functionality to use data stored in storage/memory resources of the client. The applications may perform other types of functionalities not listed above without departing from the scope of the invention. In one or more embodiments, while providing application services to a user, applications may store data that may be relevant to the user in storage/memory resources of a client (e.g., 110A, 110B, etc.).

In one or more embodiments, a client (e.g., 110A, 110B, etc.) may interact with the IN (140). For example, the client may issue requests to the IN (140) to receive responses and interact with various components of the IN (140). The client may also request data from and/or send data to the IN (140). As yet another example, a client (e.g., 110A, 110B, etc.) may utilize application services provided by the IN (140). When the client interacts with the IN (140), data that is relevant to the client may be stored (temporarily or permanently) in the IN (140).

As yet another example, consider a scenario in which the IN (140) hosts a database utilized by a client (e.g., 110A, 110B, etc.). In this scenario, the database may be a client database associated with users of the client. When a new user is identified, the client may add information of the new user to the client database. By doing so, data that is relevant to the client may be stored in the IN (140). This may be done because the client may desire access to the information of the new user at some point-in-time.

As yet another example, a client (e.g., 110A, 110B, etc.) may execute an application that interacts with an application database hosted by the IN (140). When an application upgrade is available to fix a critical software issue, the IN (140) may identify the client that requires the application upgrade. The application database may then provide the application upgrade to the client. By doing so, the application executed by the client may be kept up-to-date. As yet another example, a client (e.g., 110A, 110B, etc.) may send instructions to the IN (140) to configure one or more VMs hosted by the IN (140). In one or more embodiments, instructions may be, for example (but not limited to): instructions to configure a backup policy, instructions to take a snapshot of VM data, etc.

In one or more embodiments, to provide a consistent user experience to a user, a client (e.g., 110A, 110B, etc.) may implement virtualized (or virtual) desktop infrastructure (VDI) environment or other types of computing environments that enable remote resources (e.g., of the IN (140)) to provide computer-implemented services that appear to the user to be provided by the client. Said another way, the IN (140) may facilitate VDI functionalities of the client, in which the IN (140) may perform computations on behalf of the VDI environment(s) implemented/used by the client and provide the results of the computations to the client. By doing so, the client may be able to provide functionalities that would otherwise be unavailable due to the lack of computing resources and/or software implemented functionalities of the client.

In this manner, the client may be capable of, e.g.,: (i) collecting users' inputs, (ii) correlating collected users' inputs to the computer-implemented services to be provided to the users, (iii) communicating with the IN (140) that perform computations necessary to provide the computer-implemented services, (iv) using the computations performed by the IN (140) to provide the computer-implemented services in a manner that appears (to the users) to be performed locally to the users, and/or (v) communicating with any virtual desktop (VD) in a VDI environment of the IN (140) (using any known protocol in the art), for example, to exchange remote desktop traffic or any other regular protocol traffic (so that, once authenticated, users may remotely access independent VDs (which may accommodate customized settings) via the client).

In one or more embodiment, a VDI environment (or a virtualized architecture) may be employed for numerous reasons, for example (but not limited to): to manage resource (or computing resource) utilization, to provide cost-effective scalability across multiple servers, to provide a workload portability across multiple servers, to streamline an application development by certifying to a common virtual interface rather than multiple implementations of physical hardware, to encapsulate complex configurations into a file that is easily replicated and provisioned, etc.

In one or more embodiments, a client (e.g., 110A, 110B, etc.) may be implemented as a computing device (e.g., 1100, FIG. 11). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client (e.g., 110A, 110B, etc.) described throughout the application.

Alternatively, in one or more embodiments, similar to the IN (140), the client (e.g., 110A, 110B, etc.) may also be implemented as a logical device.

In one or more embodiments, users may interact with (or operate) a client (e.g., 110A, 110B, etc.) in order to perform work-related tasks (e.g., production workloads). In one or more embodiments, the accessibility of users to the client may depend on a regulation set by an administrator of the client. To this end, each user may have a personalized user account that may, for example, grant access to certain data, applications, and computing resources of the client. This may be realized by implementing the “virtualization” technology. In one or more embodiments, an administrator may be a user with permission (e.g., a user that has root-level access) to make changes on the client that will affect other users of the client.

In one or more embodiments, for example, a user may be automatically directed to a login screen of the client when the user connected to that client. Once the login screen of the client is displayed, the user may enter credentials (e.g., username, password, etc.) of the user on the login screen. The login screen may be a GUI generated by a visualization module (not shown) of the client. In one or more embodiments, the visualization module may be implemented in hardware (e.g., circuitry), software, or any combination thereof.

In one or more embodiments, the GUI may be displayed on a display of a computing device (e.g., 1100, FIG. 11) using functionalities of a display engine (not shown), in which the display engine is operatively connected to the computing device. The display engine may be implemented using hardware, software, or any combination thereof. The login screen may be displayed in any visual format that would allow the user to easily comprehend (e.g., read and parse) the listed information.

In one or more embodiments, the network (130) (or the “network environment”) may represent a (decentralized or distributed) computing network and/or fabric configured for computing resource and/or messages exchange among registered computing devices (e.g., the clients (e.g., 110A, 110B, etc.), the IN (140), etc.). As discussed above, components of the system (100) may operatively connect to one another through the network (130) (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network (130) may be operably connected to the Internet or other networks. Further, the network (130) may enable interactions between, for example, the clients and the IN through any number and type of wired and/or wireless network protocols (e.g., TCP, UDP, IPv4, etc.). Further, the network (130) may be configured to perform all, or a portion, of the functionality described in FIGS. 3.1-3.3.

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network (130), and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VOIP), etc.

In one or more embodiments, the non-real-time network traffic may be low-priority (e.g., non-urgent) network traffic. For this reason, data packets of the non-real-time network traffic may not need to be prioritized in the network (130). The non-real-time network traffic may include data packets related to, for example (but not limited to): File Transfer Protocol (FTP) for web publishing, email applications, etc.

Turning now to FIG. 2, FIG. 2 shows a diagram of an IN (200) in accordance with one or more embodiments of the invention. The IN (200) may be an example of an IN discussed above in reference to FIG. 1. The IN (200) may include an orchestrator (202), an analyzer (204), and an engine (206). The IN (200) may include additional, fewer, and/or different components without departing from the scope of the invention. Each component may be operably connected to any of the other component via any combination of wired and/or wireless connections. Each component illustrated in FIG. 2 is discussed below.

In one or more embodiments, the IN (200) may include a frame (not shown) and any number of chassis (not shown). The frame may be a mechanical structure that enables chassis to be positioned with respect to one another. For example, the frame may be a rack mount enclosure that enables chassis to be disposed within it. The frame may be implemented as other types of structures adapted to house, position, orient, and/or otherwise physically, mechanically, electrically, and/or thermally manage chassis. By managing the chassis, the frame may enable multiple chassis to be co-located.

In one or more embodiments, a chassis may be a mechanical structure for housing at least the aforementioned components of the IN (200). For example, a chassis may be implemented as a rack mountable enclosure for housing the aforementioned components of the IN (200). The chassis may be adapted to be disposed within the frame.

In one or more embodiments, the orchestrator (202) may include functionality to, e.g.,: (i) generate all of the housekeeping for a VDI environment of the IN (200) (e.g., deploying/establishing VDs, managing one or more VD pools, managing the execution of operations on VDs (e.g., managing services to be provided by a VD based on the validity and user level of a user, managing workload placement among VDs, tracking VD capabilities and resource availabilities, etc.), associating a VD pool with a master image, managing VD state policies, etc.); (ii) perform various management functions and be responsible for overseeing operations and maintenance pertinent to the hardware, software, and/or firmware elements of the IN (200) (e.g., the analyzer (204), the engine (206), etc.); (iii) execute any computer-readable program code, firmware/software, hardware, or combinations thereof that helps to generate VDs being executed on the VDI environment; (iv) execute computing system virtualization application(s) that may be accessed by clients (e.g., 110A, 110B, etc., FIG. 1); (v) execute any computer-readable program code that connects clients to VDs; (vi) be responsible for the authentication of users of clients and direct those users to their respective VDs; (vii) keep track of active and inactive VDs; (viii) provide a remotely-accessible user interface to an administrator to manage the configuration of VD pools (e.g., a management terminal provided by the orchestrator (202) may allow an administrator to perform computing system virtualization management functions via a secure management session); (ix) control the lifecycle of VDs executing on the VDI environment; (x) perform power operations on VDs (i.e., power on, power-off, suspend, resume, checkpoint, etc.); (xi) group two or more VDs to generate one or more VD pools; (xii) allocate computing resources available in the VDI environment to generate one or more VD pools; (xiii) prevent unauthorized access events directed to the VDI environment; (xiv) provide an out-of-band communication channel to applications executing on a VD; (xv) monitor/aggregate/track various performance and health (e.g., operation condition) information of VDs, the analyzer (204), and the engine (206); (xvi) obtain (or retrieve) an asset dataset (AD) (described below) from the assets database (e.g., 121, FIG. 1) and provide/send the AD to the analyzer (204); (xvii) obtain (or retrieve) a sale transactions dataset (STD) (described below) from the transactions database (e.g., 122, FIG. 1) and provide/send the STD to the analyzer (204); (xviii) obtain (or retrieve) an economic and demographic dataset (EDD) (described below) from the demographics database (e.g., 124, FIG. 1) and provide/send the EDD to the analyzer (204); (xix) obtain (or retrieve) a market dataset (described below) from the market information database (e.g., 125, FIG. 1) and provide/send the market dataset to the analyzer (204); (xx) obtain (or retrieve) an asset characteristics dataset (ACD) (described below) from the assets' characteristics database (e.g., 126, FIG. 1) and provide/send the ACD to the analyzer (204); (xxi) obtain (or retrieve) a location dataset (LD) (described below) from the location information database (e.g., 128, FIG. 1) and provide/send the LD to the analyzer (204); (xxii) obtain (or retrieve) a valuation asset dataset (VAD) (described below) from the valuation information database (e.g., 129, FIG. 1) and provide/send the VAD to the analyzer (204); (xxiii) support fundamental IN functions (e.g., schedule tasks, allocate IN resources, execute management applications and/or processes, manage peripherals (e.g., I/O devices) connected to the IN (200), etc.); and/or (xxiv) store (temporarily or permanently) information/data related to (i)-(xxiii) in a storage/memory resource of the IN (200).

In one or more embodiments, the AD may include (or specify), for example (but not limited to): an in-place lease document, information in relation to an in-place rent roll, information in relation to a known operating expense, information in relation to known capital expenditure, information in relation to a lease expiry date and time, county asset tax records, information in relation to a lease renewal option, information in relation to a tenant improvement, information in relation to a free rent period, parcel records, etc.

In one or more embodiments, the STD may include (or specify), for example (but not limited to): a sales price of an asset, location information, a type of a sale event, a price of a sale event, a close date of an asset, a recorded date of an asset, etc.

In one or more embodiments, the EDD may include (or specify), for example (but not limited to): a population of an area/region, an average income of a person living in the area, a type of an employment available in the area, information in relation to a migration pattern in the area, etc.

In one or more embodiments, the MD may include (or specify), for example (but not limited to): existing asset supply information, a vacancy status of an asset, information in relation to supply net absorption, information in relation to a new supply pipeline, information in relation to an asking rent, etc.

In one or more embodiments, the ACD may include (or specify), for example (but not limited to): an age of an asset, a health condition of an asset, building quality of an asset (e.g., a subjective rating, typically with A being the highest quality asset, followed by B and C, and D being the lowest quality asset), a size of an asset, a size of a lot that hosts an asset, a description of an asset, an attribute of an asset, a type of an asset, asset and land characteristics form image data, a net rentable area (e.g., how much space can be rented), a number of units (e.g., for a multifamily asset), presence of amenities (e.g., a pool, a doorman, etc.), a location address of an asset, etc.

In one or more embodiments, the LD may include (or specify), for example (but not limited to): a point of interest nearby an asset, a zoning code, a distance to a transportation system, information in relation to transit times, information in relation to a geographic region, a type of a tenant (e.g., a high-end tenant that requires a high-end asset in a rich environment, a low-end tenant, etc.), etc.

In one or more embodiments, the VAD may include (or specify), for example (but not limited to): location information of an asset, asset information regarding valuation “as of” date, etc. In one or more embodiments, the VAD either has to include the required information from the AD (e.g., in-place leases, rent rolls, known operating expenses, known capital expenditures, etc.), or the AD must include this information for a valuation asset already. In the latter case, the VAD may actually just have the location information of the asset and the asset information regarding valuation as of date because the above required information may be obtained from the AD.

One of ordinary skill will appreciate that the orchestrator (202) may perform/provide other functionalities without departing from the scope of the invention. When providing its functionalities, the orchestrator (202) may perform all, or a portion, of the methods illustrated in FIGS. 3.1-3.3. The orchestrator (202) may be implemented using hardware, software, or any combination thereof.

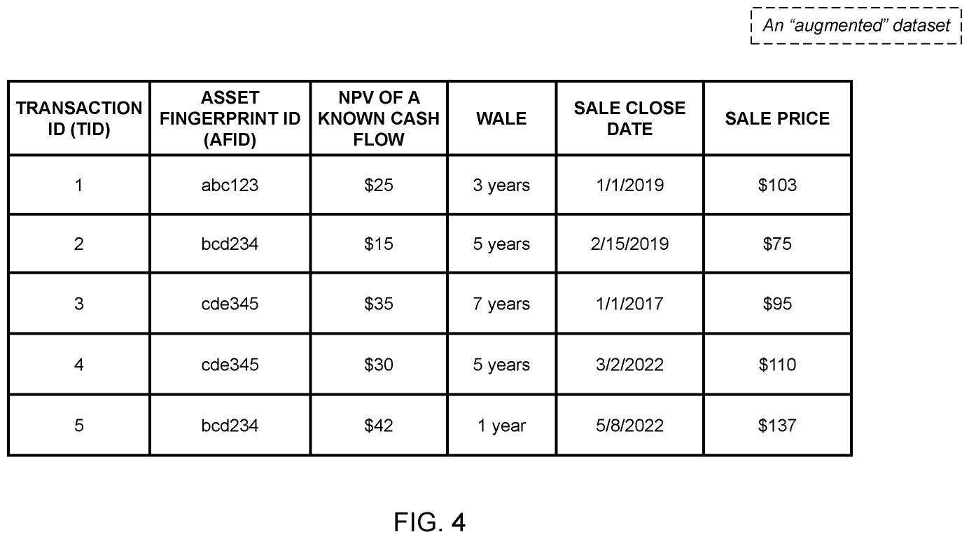

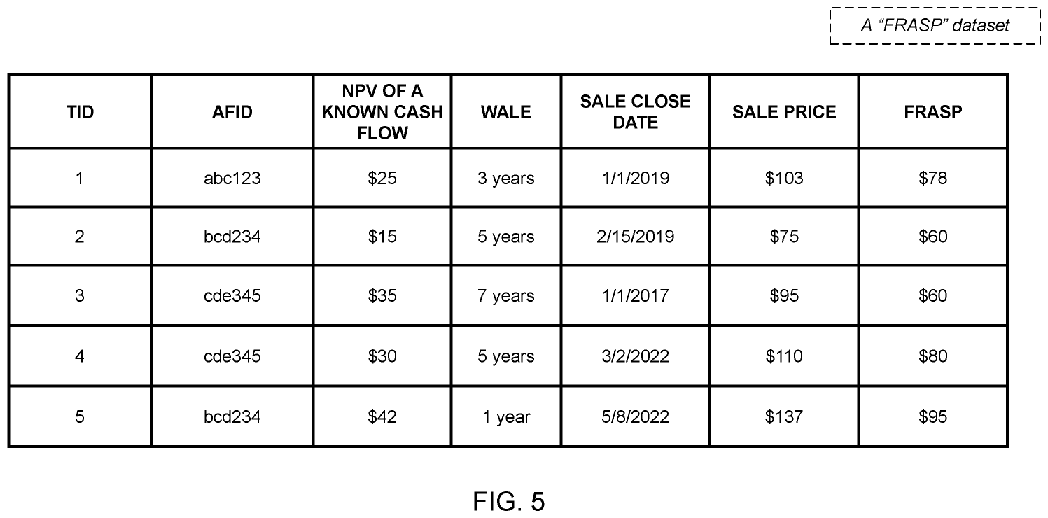

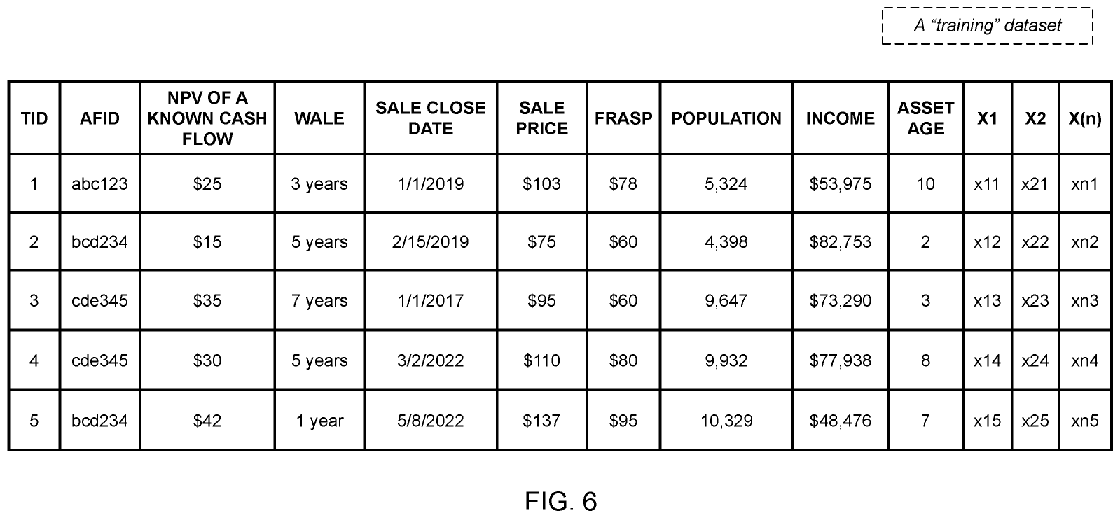

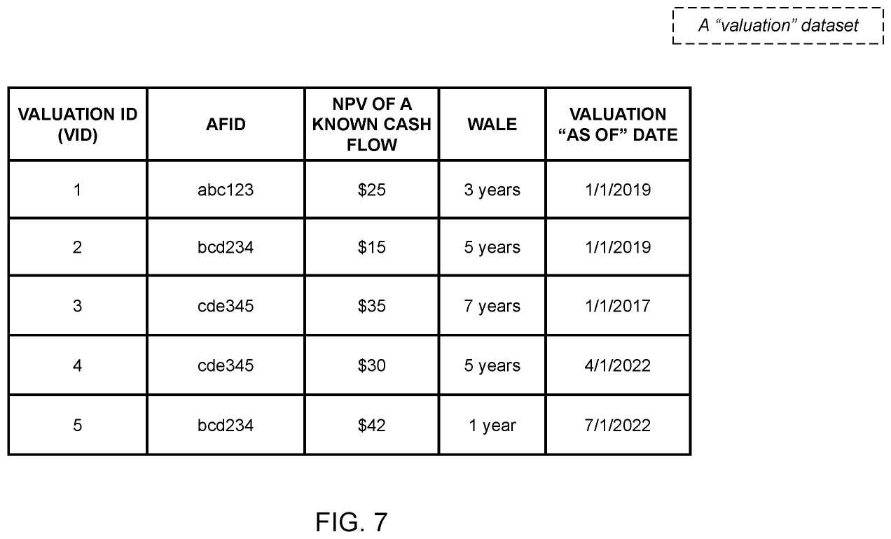

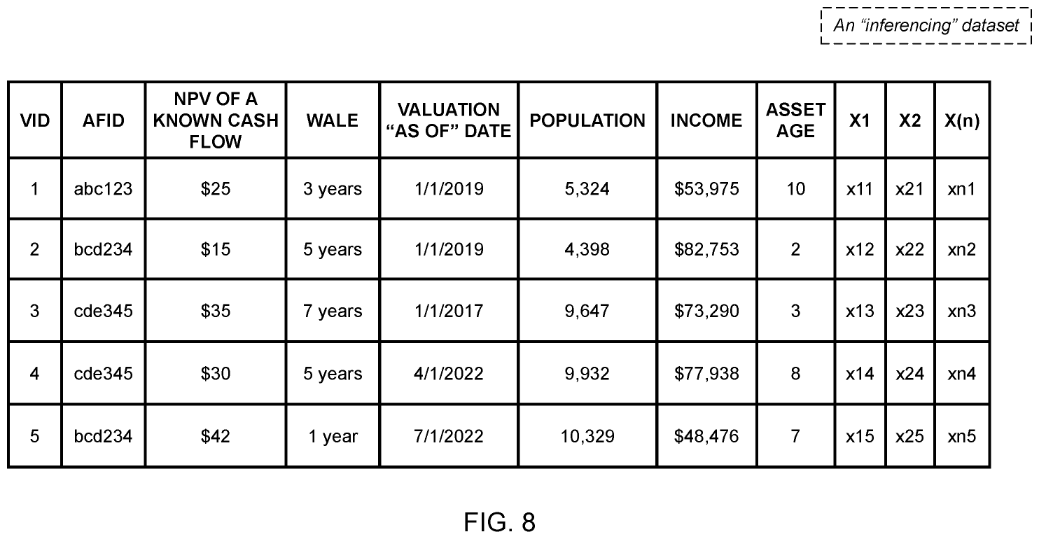

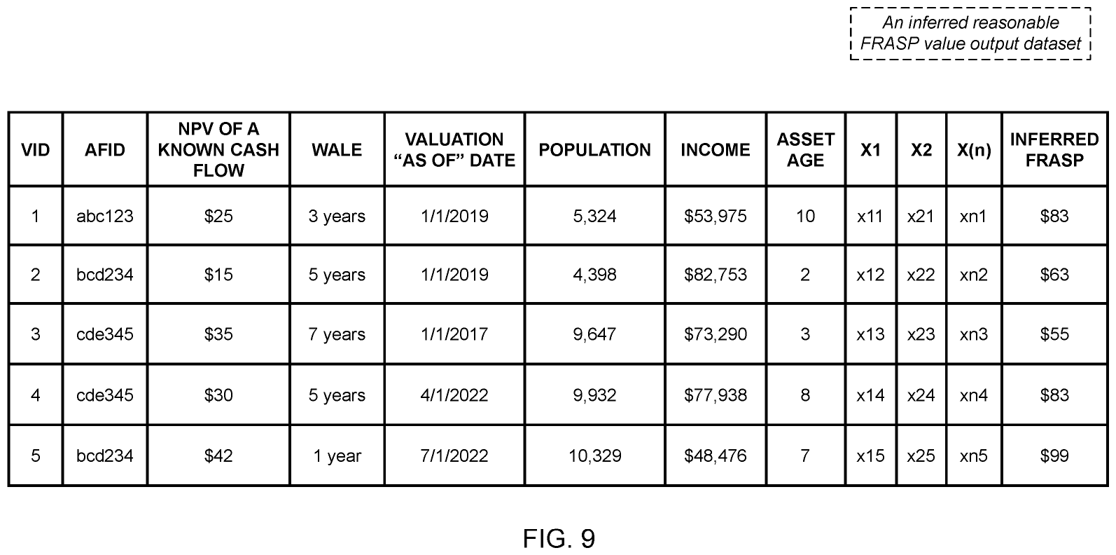

In one or more embodiments, the analyzer (204) may include functionality to, e.g.,: (i) analyze an AD (which is received from the orchestrator (202)) to generate a WALE of a known lease and to generate an NPV of a known CF; (ii) based on (i), combine the NPV of the known CF, WALE of the known lease, and an STD (which is received from the orchestrator (202)) using a unique asset fingerprint (described above in reference to FIG. 1) to generate an augmented dataset (or an “augmented CF+sales price dataset”, see FIG. 4); (iii) based on the augmented dataset, obtain a FRASP (or a FRASP value) for a transaction; (iv) based on the FRASP value for the transaction, generate a FRASP dataset (or an “income-adjusted sales price dataset”, see FIG. 5) from the augmented dataset; (v) based on the FRASP dataset, combine an EDD, MD, ACD, and LD (which are received from the orchestrator (202)) to generate a training dataset (see FIG. 6); (vi) based on (v), instruct the engine (206) to generate a model (e.g., an ML model, a regression model, a trained model, etc.) that predicts FRASP values for transactions and send the training dataset to the engine (206); (vii) combine the NPV of the known CF, WALE of the known lease, and VAD using the unique asset fingerprint to generate a valuation dataset (see FIG. 7); (viii) based on (vii), combine the valuation dataset with the EDD, MD, ACD, and LD to generate an inferencing dataset (see FIG. 8); (ix) based on (viii) and a trained model (trained by the engine (206)), instruct the engine (206) to infer a reasonable FRASP value for an asset valuation and send the inferencing dataset to the engine (206): (x) based on (ix), append the “inferred” FRASP value of the asset to the inferencing dataset to generate an inferred reasonable FRASP value output dataset (see FIG. 9); (xi) based on the inferred FRASP value of the asset and NPV of the known CF, generate a final asset valuation value output for the asset; (xii) initiate a display of the final asset valuation value output to a user/administrator on a GUI (for example, of a client (e.g., 110A, FIG. 1)); and/or (xiii) store (temporarily or permanently) information/data related to (i)-(xii) in the storage/memory resource of the IN (200).

As used herein, a “known CF” is a CF (including both revenue and expenses) associated with contracted current or future tenants. Examples of known CFs may include (but not limited to): Company X has a contracted lease for 10 k square feet in an office building in Miami between June 2019 and May 2029, in which the rental revenue from this lease is more-or-less guaranteed; for this lease, the office may have some expenses covered by a landlord (e.g., an asset owner), in which these expenses to be known and forecastable with high-precision; if today is September 2023 and Company T has a contract signed for a lease beginning on a future date (e.g., December 2023), Company T would consider a rental revenue and expense schedule from that lease to be known; etc.

Regarding the “WALE of a known lease”, for example, an asset may have many tenants, each of whom may have a different lease expiration date. The WALE refers to the remaining time to lease maturity across all tenants, in which each tenant's remaining lease time to maturity is weighted by square footage (sf) it occupies. If a 100 k sf tenant has a lease expiry in 15 years and a 200 k sf has a lease expiry in 12 years, the WALE is 13 years ((100/300)×15+ (200/300)×12=13 years). As indicated, the WALE is a calculated/known value, in which the coefficients for assessing the impact of different WALEs on the corresponding FRASP value may be determined by employing a linear, non-linear, and/or ML model.

In one or more embodiments, for all transactions in the market, the analyzer (204) implements the CFAC AVM approach by breaking prices up into two components, (a) in-place lease contributions to an asset value (e.g., already contracted (or guaranteed) CFs from rents and expenses associated with that, the NPV of in-place CFs, etc.) and (b) residual value of the asset (e.g., assumed lease contribution to the asset value and reversion contribution to the asset value, the FRASP value contribution (which may be predicted from a large volume of comparable historical transactions), etc.), and by taking the net transaction value for an asset sold in the market and subtracting the discounted value of in-place leases and associated expenses, obtains the residual value as the “WALE/WALT adjusted asset value” (which is independent of CFs and is the actual price that a tenant needs to pay to own the asset and/or to lease it up and have CFs WALT years in the future (e.g., for a typical office asset, 6 or 7 years from now, what amount should a tenant needs to pay to own the asset and/or to lease is up)).

For example, assume here that: (i) sale transaction T1=$100, (ii) sale transaction T2=$80, (iii) sale transaction T3=$90, (iv) sale transaction T4=$70, and (v) sale transaction T5=$100. By implementing the CFAC AVM approach, the analyzer (204) may break up each sale transaction into (a) in-place discounted CFs (e.g., the “income-adjusted” part of the CFAC AVM approach) and (b) residual (e.g., the “comps-based” part of the CFAC AVM approach), and then implement a model (e.g., the “AVM” part of the CFAC AVM approach, in which the model is trained based on income-adjusted transaction prices in a given WALT (e.g., how much is left in the contract?), asset characteristics (e.g., the quality of an asset, the age of an asset, etc.), economic/demographic conditions, location conditions, market conditions (e.g., health of the market may affect the transaction prices (e.g., an asset's sell price excluding all fees and transfer taxes)), etc., to predict the residual).

To this end, the analyzer (204) may obtain: (1) for T1, in-place CF=$30 and residual=$70; (2) for T2, in-place CF=$30 and residual=$50; (3) for T3, in-place CF=$40 and residual=$50; (4) for T4, in-place CF=$40 and residual=$30; and (5) for T5, in-place CF=$40 and residual=$60. As indicated, T2 and T3 (or those two assets) are sold for two different prices, which is due to in-place lease/CF differences, and what a tenant needs to pay to own the asset (and get the related CFs in the future), the residual, is the same (i.e., $50) in T2 and T3 (e.g., the underlying residual portion of the asset is priced the same), which is reflected by the trained model.

As indicated above, by implementing the CFAC AVM approach, the analyzer (204) may perform asset value conclusion/valuations based on (or sum of the following two portions): (i) the DCF (e.g., only currently known in-place CFs such as lease payments, expenses, loan payments, annuity payments, etc.) portion in relation to an asset and (ii) the AVM based prediction portion for the residual value of the asset (e.g., the AVM based prediction for WALT-adjusted asset values). With the help of the CFAC AVM approach (which is more unbiased, scientific, scalable, and quick approach to pricing asset attributes and location information comparing to the comps or DCF approach), the only explicit assumptions one may need to make are the discount rate for the in-place CFs and any type of expenses during the contracted lease term (e.g., during the WALT).

In an example scenario, the analyzer (204) may implement the CFAC AVM approach by defining y_{i,t}=S_{i,t}−cf_{i,t} as the price paid for the right to own an asset in “x” years with no CF until such time (e.g., the remaining value of the asset), in which S_{i,t} is the net transaction sales price for the asset “i” at time “t”, cf_{i,t} is the NPV of CFs from in-place leases and associated expenses, and x is the WALE for the in-place CF for asset i at time t. Here, by definition, y_{i,t} is independent of existing CFs and y_{i,t} may be modeled as a function of location quality, market characteristics, asset attributes, and an adjustment based on the magnitude of X: y_{i,t}=f(location_{i,t}, market_{i,t}, asset_{i,t}, x_{i,t}, . . . ). Then, for an asset and based only on the in-place CFs and the WALT, x, remaining at time t, a reasonable asset value may be calculated as Ŝ_{i,t}=cf_{i,t}+ŷ_{i,t} where ŷ_{i,t} is a model estimate of f(location_{i,t}, market_{i,t}, asset_{i,t}, x_{i,t}, . . . ) that minimizes a loss function (e.g., y_{i,t} is the predicted price that a tenant would pay for the asset after stripping out known (or highly certain) CFs). In this scenario, as cf_{i,t}→0, Ŝ_{i,t}→ŷ_{i,t}, which is a specific AVM approach for short duration lease assets (e.g., a single family asset, a multifamily asset, etc.). This means that previous regression-based AVM approaches are a special case of the CFAC AVM approach.

As used herein, a “remaining value of an asset” refers to a theoretical quantity defined by subtracting an NPV of known CFs of the asset from the corresponding sale transaction price.

As used herein, market characteristics refer to measurements of economic, financial, CRE performance, and/or demographic conditions in a surrounding region (e.g., a metropolitan statistical region (as defined by the Office of Management and Budget), a county, a city, a submarket (e.g., a sub-city geographic region with similar characteristics based on density, zoning, income, and/or CRE asset concentration), etc.). In one or more embodiments, market characteristics may include, for example (but not limited to): an average effective rent, an occupancy or vacancy status (as a percentage of total available space within the defined surrounding region), a change in average effective rent from last year to current year, etc.

For example, if a building sold for $10 m on Jan. 1, 2023, and the NPV of the in-place leases and expenses as of January 1 was $3 m, this remaining value of the building would be $7 m. In this example, the $7 m would be the FRASP value.

As a result, by implementing the CFAC AVM approach, the analyzer (204) (in conjunction with the engine (206)) may, for example, help a tenant that states “I have this asset with X amount of CF and a WALT on those CFs of 3 years” by providing what the total value of the asset is by predicting Jit by adding the discounted known CFs. To do that, the analyzer (204) (in conjunction with the engine (206)) may use this example structure:

$${\hat{y}}_{i , t} = {β}_{0} + {β}_{1} * WALT + {β}_{1} * BuildingAge + {β}_{2} * LocationQuality + {β}_{3} * MarketRenewalProbability + {β}_{4} * TenantQuality + {β}_{5} * StabilizedOccupancyRate + {β}_{6} * NeighborhoodGrowth + TimeFixedEffects .$$

Those skilled in the art will appreciate that while the above structure is shown as an example structure, any other model/approach and any other variable/parameter may be used to provide the total value of an asset without departing from the scope of the invention.

To this end, the CFAC AVM approach addresses the flaws of the comparables approach by directly adjusting for differences in value due to different in-place tenant CFs (e.g., differences in value may indicate the fact that two identical assets, adjacent to each other on the same street, may have different values/sales prices solely due to in-place leases). For example, consider a scenario where two assets (Asset A and Asset B) are the same in every manner (e.g., the same size, the same height, equal quality, the same age, etc.) except Asset A currently has a tenant paying $100 per year for the next 10 years while Asset B has a tenant paying $100 per year for the next 2 years. Both assets are in a market that is deteriorating (e.g., rents are declining and occupancy is falling). Because both assets should expect a new tenant to pay less than their existing tenants (or they may find it impossible or expensive to lease the space at all), the fact that Asset A has a longer guaranteed stream of $100 in revenue has additional value relative to Asset B's 2-year stream of $100 per year. Thus, Asset A should sell for more money than Asset B, which is a common event in the CRE because lease contracts are complex and variable compared to residential real estate.

One of ordinary skill will appreciate that the analyzer (204) may perform/provide other functionalities without departing from the scope of the invention. When providing its functionalities, the analyzer (204) may perform all, or a portion, of the methods illustrated in FIGS. 3.1-3.3. The analyzer (204) may be implemented using hardware, software, or any combination thereof.

In one or more embodiments, the engine (206) may include functionality to, e.g.,: (i) receive an instruction (or a command) to generate a model (e.g., an ML model, a trained model, etc.) that predicts a FRASP value for a transaction; (ii) upon receiving a TD and by employing a set of linear, non-linear, and/or ML models, generate a model by training the model (i.e., the trained model) using the TD; (iii) initiate notification of an administrator about the generated trained model (for example, to indicate that the trained model is ready for next steps such as the “inferencing phase” (see FIG. 3.3)); (iv) receive an instruction (or a command) to infer a reasonable FRASP value for an asset valuation; (v) infer, using the trained model (generated in (ii)) and an inferencing dataset received from the analyzer (204), the reasonable FRASP value for the asset valuation (e.g., a FRASP value of the real property asset (e.g., a commercial building such as a retail building, an entertainment venue, a warehouse, an office building, etc.; a non-commercial building; etc.)); (vi) provide/send the inferred reasonable FRASP value (of the real property asset) to the analyzer (204); and/or (vii) store (temporarily or permanently) information/data related to (i)-(vi) in a storage/memory resource of the IN (200).

In one or more embodiments, generation of a “trained model” is a statistical/ML approach that generates the trained model that predicts a FRASP value for an arbitrary transaction (described below) given, at least, the WALE value, EDD, CRE MD, ACD, and LD. The engine (206) may generate a “trained model” in two steps: (a) the “feature engineering and feature selection” step, and (ii) the “model selection and model tuning” step.

As used herein, (i) “feature engineering” is a process by which the engine (206) curates the characteristics and data that the trained model will consider to predict a FRASP, and (ii) “feature selection” is a process by which the engine (206) chooses which characteristics/features the trained model will consider to predict the FRASP.

As used herein, (i) “model selection” is a process by which the engine (206) selects optimal modeling approaches to use for predicting a FRASP, and (ii) “model tuning” is a process by which the engine (206) configure/parameterize a modeling approach to improve its performance for predicting the FRASP.

As used herein, an arbitrary transaction refers to a real or hypothetical sale for any asset. As discussed throughout the application, with the help of the CFAC AVM approach, one may predict the selling price for any CRE asset at a given point-in-time. In CRE, assets may sell infrequently. To this end, the CFAC AVM approach would generate a prediction of what any provided asset would sell for in a competitive bidding process at that point-in-time.

For example, prior to training a model (e.g., a random forest regression model, a gradient boosting regression model, an XGBoost model, etc.), the engine (206) may select the model from multiple models (e.g., selecting a model that provides the highest performance, as measured by minimizing a loss function on a holdout/training dataset). The engine (206) may then select one or more features (e.g., a first feature, a second feature, etc.) that will be considered by the model while generating a trained model. The first feature may specify, at least, a population of a region, an average income of a person/tenant living in the region, an age of the corresponding asset, information from a database of the databases (e.g., 120, FIG. 1), etc. The second feature may specify, at least, information in relation to supply net absorption, information in relation to an asking rent, information in relation to a location, information from a database of the databases (e.g., 120, FIG. 1), etc.

In one or more embodiments, in order to select a model, the engine (206) may check/calculate, for example (but not limited to): mean absolute percentage error score/performance of a model, root mean squared score/performance of a model, etc. In order to tune/train a “selected” model, the engine (206) may implement, for example, GridSearchCV for hyperparameters. Further, while selecting a feature, the engine (206) may use, for example (but not limited to): a recursive feature elimination model, the Boruta approach/algorithm, etc.

One of ordinary skill will appreciate that the engine (206) may perform/provide other functionalities without departing from the scope of the invention. When providing its functionalities, the engine (206) may perform all, or a portion, of the methods illustrated in FIGS. 3.2 and 3.3. The engine (206) may be implemented using hardware, software, or any combination thereof.

In one or more embodiments, the orchestrator (202), the analyzer (204), and the engine (206) may be utilized in isolation and/or in combination to provide the above-discussed functionalities. These functionalities may be invoked using any communication model including, for example, message passing, state sharing, memory sharing, etc. By doing so, the IN (200) may address issues related to data security, integrity, and availability proactively.

Further, some of the above-discussed functionalities may be performed using available resources or when resources of the IN (200) are not otherwise being consumed. By performing these functionalities when resources are available, these functionalities may not be burdensome on the resources of the IN (200) and may not interfere with more primary workloads performed by the IN (200).

FIGS. 3.1 and 3.2 show a method for generating a FRASP model in accordance with one or more embodiments of the invention. More specifically, (i) FIGS. 3.1 and 3.2 show the initial “ML model training and load-testing phase” of the overall method to generate a trained model that predicts a FRASP (or a FRASP value) of a real property asset, and (ii) FIG. 3.3 shows the “inferencing phase” of the overall method to infer an asset valuation value for the asset. While various steps in the method are presented and described sequentially, those skilled in the art will appreciate that some or all of the steps may be executed in different orders, may be combined or omitted, and some or all steps may be executed in parallel without departing from the scope of the invention.

Turning now to FIG. 3.1, the method shown in FIG. 3.1 may be executed by, for example, the above-discussed orchestrator (e.g., 202, FIG. 2) and the analyzer (e.g., 204, FIG. 2). Other components of the system (100) illustrated in FIG. 1 may also execute all or part of the method shown in FIG. 3.1 without departing from the scope of the invention.

In Step 300, the orchestrator receives a request from a requesting entity (e.g., a user/customer of a client (e.g., 110A, 110B, etc., FIG. 1), an administrator terminal, etc.) that wants to know a value of a real property asset (e.g., to own the asset or to lease it up). In response to receiving the request, as part of that request, and/or in any other manner, the orchestrator obtains (or retrieves) an AD (e.g., existing contracts, financial metrics, etc.) from the assets database (e.g., 121, FIG. 1). The orchestrator may then send the AD to the analyzer.

In one or more embodiments, the AD may be obtained/accessed (for example, by querying the assets database) to obtain data to be used in, at least, (i) generating/calculating a WALE of known leases (see Step 302) and (ii) generating an NPV of known CFs (e.g., a guaranteed CFs calculation using a DCF model, see Step 304). Certain details of the AD are described above in reference to FIG. 1.

In Step 302, the analyzer analyzes the AD to generate a WALE of a known lease. In Step 304, the analyzer analyzes the AD to generate/calculate an NPV of a known CF (e.g., an in-place discounted CF). For the calculation, the analyzer may implement a linear, non-linear, and/or ML model that categorizes leases as being in-place/known or unknown, and returns a vector of CFs that are associated with known CFs. To this end, a version of a CF with no speculative tenants and all other calculations (e.g., operating expenses) may be performed based on “no speculative tenant”, in which speculative tenants are assumed unknown in the CFAC AVM approach.

The NPV of this vector of CFs is the sum of the discounted CFs, using a “risk adjusted discount rate”, relative to the effective date of the valuation. For example, consider a scenario where an administrator has 3 years of known CFs and the discount rate (r) is 5%: (i) Year 1 CF is $10, (ii) Year 2 CF is $11, and (iii) Year 3 CF is $12. The resulting NPV of these CFs becomes the sum of CF/(1+r)^{year}, which is 29.867.

In most cases, the existing DCF methodology/approach implements an appraiser-determined discount rate, for example, to the first 10 years' of CFs (e.g., the same rate to all CFs) and then applies a “terminal cap rate” to the beginning of “year 11 NOI” in order to derive a sales price (or a reversion value) that is then discounted back to today. The sum of all present valued figures (e.g., CFs, a reversion value, etc.) is then called the “value conclusion”.

Further, under the existing DCF approach, a single discount rate is applied to all CFs-known and unknown-over, for example, a 10-year span. This discount rate (i) does not explicitly account for the probability of non-payment by any individual lessee, (ii) does not distinguish between the riskiness of known versus unknown CFs of future tenant(s), (iii) does not account for length of the weighted-average lease length of known CFs, (iv) is used as a one-size-fits-all method for adjustment of factors not related to probability of payment (e.g., asset attributes), and/or does not take into account the credit risk of the tenants behind the lease CFs or the term structure of the government bond curve. For at least the aforementioned reasons, CFs of riskier tenants that are set to occur further in the future should have a higher interest rate than CFs (a) for the same tenant closer in the future or (b) for a less risky tenant at the same point in the future. However, the existing DCF approach does not consider these factors.

As used herein, (i) a “discount rate” refers to a required return or an internal rate of return (IRR), in which more risky assets have higher discount rates to account for more risk (e.g., the discount rate is today's cap rate and the growth in expected CFs over the next 10 years; the discount rate represents the return that investors need to earn on their CFs over the next decade; etc.), and (ii) a “terminal cap rate” refers to the cap rate that is used to calculate the resale value of an asset at reversion (e.g., the terminal cap rate may be 10 years out, which may be higher to account for the asset being older and risk given unknowns over 10 years; the terminal cap rate is the expected yield on an asset at sale in year 10; etc.).

To this end, in order to (i) calculate/generate guaranteed CFs and (ii) make a judgment for the guaranteed CFs (because, for example, even the CFs are contracted, there still may be a risk (e.g., the lessee is unable to pay and vacate the asset (may occur in the event of bankruptcy) or the lessor receives less than the full amount of lease payments based on the proceeds to creditors in liquidation; the lessee terminates the lease early and any buy-out of the remaining lease obligation results in proceeds that are les than the full amount of the lease obligation; etc.)), the analyzer may consider a “risk-adjusted” discount rate to apply to the contracted leases.

Further, while implementing the CFAC AVM approach, the analyzer may use a risk adjusted discount rate only for the CFs from known leases, in which these CFs should accurately reflect (1) the credit risk and likelihood of payment from each individual tenant and/or (2) any term structure/liquidity premia (e.g., CFs that will occur in the future are considered riskier then CFs that will occur closer to today, in which interest rates for longer maturities are higher than interest rates for shorter maturities; higher compensation may be needed (in the form of higher interests rates or higher returns) for CFs in the future (that may be less liquid); higher spreads for any given CF may translate to a higher risk; etc.). To this end, the CFAC AVM approach will be consistent with the valuation of corporate bonds from a risk and maturity perspective and should lead to a valuation more consistent with actual risks.

For example, consider a scenario where Company A has refused to pay some of its monthly lease payments in Austin, whereas Company G (which is also an office tenant) always pays its rent on time. The lease payments from Company A should be considered riskier than the lease payments from Company G, and as a result, should have a higher discount rate applied to them (e.g., higher discount rates→lower present values).

In Step 306, in response to receiving the request (in Step 300), as part of that request, and/or in any other manner, the orchestrator obtains (or retrieves) an STD from the transactions database (e.g., 122, FIG. 1). The orchestrator may then send the STD to the analyzer. In one or more embodiments, the STD may be obtained/accessed (for example, by querying the transactions database) to obtain data to be used in, at least, combining the NPV of the known CF, WALE of the known lease, and STD (see Step 308). Certain details of the STD are described above in reference to FIG. 1.

In Step 308, upon receiving the STD from the orchestrator (in Step 306), the analyzer combines/assembles the NPV of the known CF, WALE of the known lease, and a “filtered” STD (described below) using a unique asset fingerprint to generate an augmented dataset (see FIG. 4). In one or more embodiments, to generate the augmented dataset (or the “augmented CF and sales price dataset”), the analyzer may, at least, (i) associate the model (used in Step 304) with a unique asset fingerprint, (ii) identify and associate the correct one of many transactions for the fingerprinted asset, and (iii) a historical view of a KG that may be “as of” the targeted date (in order to confirm/verify the obtained unique asset fingerprint because parcel structures today may be different than in the past, for example, a transaction may have occurred purchasing 5 tax parcels 10 years ago, but those were redeveloped and collapsed into a single parcel).

In one or more embodiments, the aforementioned model may refer to a specific combination of actual data, assumptions, and/or calculations for an asset. An asset may have many models associated with it, which may differ for many reasons, for example (but not limited to): a period of time that has passed (e.g., a user generated Model 1 by entering data, assumptions, and executing calculations on January 1^{st}, then, on April 1^{st}, the user copied Model 1 (by making a new instance of) to generate Model 2 and then modify the data and assumptions using Model 2), testing different scenarios (e.g., a user generated Model 3 by entering data, assumptions, an executing calculations on January 1^{st}, where the user then copies Model 3 to generate Model 4 in order to (a) change an assumption about a tenant by adjusting the likelihood of renewal from 70% to 0% and (b) measure a hypothetical impact of the tenant departing the corresponding asset), etc.

As described above in reference to FIG. 1 and with the help of the orchestrator, the analyzer may send a location address of the related asset (e.g., 123 Target St, Maintown, Miami) to the production agent of the mapping server (e.g., 150, FIG. 1), and in return, may receive back a unique asset fingerprint for the parcel associated with this address (e.g., a unique identifier that specifies a parcel associated with the location address of the asset). For example, upon receiving, via an API call, an address of an asset from the orchestrator, the production agent may perform an address lookup via a service provider and receive a latitude-longitude pair. The production agent may then search for a set of parcel shapes for the parcel containing latitude-longitude pair, or the one closest to the targeted one. Thereafter, the production agent may return the corresponding unique asset fingerprint of the asset (for the parcel shape returned as a result of the search process) to the orchestrator for further processing, which is then forwarded to the analyzer.

In one or more embodiments, a user/customer may define an asset that does not align one-to-one with a tax lot/parcel, not with an address. For example, the model (described above) may be associated with one or more tax lots, zero or more assets, and multiple addresses (e.g., assets and units that have at least one mailing address each). If this is the case, the production agent may return the corresponding unique asset fingerprint of the asset using its assemblage model (described above in reference to FIG. 1).

In one or more embodiments, an asset may have many different transactions across time, some of which are sales for the purpose of the CFAC AVM approach, and others of which are non-sale transactions. For example, an arms-length transaction/sale is typically a sale (e.g., this type of transaction may have partial sales where a fraction of an ownership is sold; however, the analyzer may exclude/filter a partial sale because the sale of a 55% fractional interest in an asset is not equal to 5 times of the sales price of a 11% fractional interest in an asset given voting control rights). As yet another example, a related-party transaction is typically a non-sale transaction, which may tend to not report related prices (which will be filtered by the analyzer because this transaction would not reflect a market-determined transaction price).

In order to identify and associate the correct one of many transactions for the fingerprinted asset to use the CFAC AVM approach more efficiently, the analyzer may filter/classify transactions (using the STD, while generating the augmented dataset) based on one or more factors, for example (but not limited to): an “arms-length” factor, a “multi-parcel sales/assemblage sales” factor, a “reasonable price per unit of area (e.g., square footage, number of doors, etc.)” factor, etc. After a filtered STD is obtained, for example, information (e.g., asset attributes) about the asset may be obtained based on the asset's unique fingerprint. The corresponding KG may provide relevant information in order to determine whether a transaction matches any of the above classification factors and should therefore be excluded.

As used herein, multi-parcel or assemblage sales refer to a bulk sale, in which more than one asset is traded as part of a portfolio. Because a bulk sale involves a group of assets but only one aggregate sales price, the corresponding transaction value of an asset may not be known, and as a result, these sales may need to be excluded. In particular, the CFAC AVM approach may look at an individual sales transaction and the value of its associated, unique characteristics.

In one or more embodiments, to generate the augmented dataset and to link a transaction to a correct model, the analyzer may (i) identify an asset owner (or a seller) based on the seller information listed on the transaction (e.g., using a KG), (ii) identify a set of potential models from the seller's database (e.g., a cloud database that may include unique historical, real-time, and future insights (related to assets) from investors across the CRE lifecycle) based on the associated asset fingerprint for the models (e.g., there may be multiple models for an asset due to recurring valuations, sensitivity analyses, underwriting events, etc.), and/or (iii) based on a purpose segmentation system (described below), comparison of model modification/analysis dates, transaction date (e.g., a date that is used for underwriting of a sale (of an owned asset), which will be later than the “last modified” date showing when the corresponding model was actively used), select a model that most likely to be used for underwriting the sale (which may have the most accurate reflection of a current contracted rent and expenses at the time of sale).

As used herein, a purpose segmentation system is a classification model that attempts to divide models into two categories ((a) a model for already-owned assets and (b) a model for assets that are under consideration for purchase). Users may apply different assumptions to different categories of models.

In Step 310, based on the augmented dataset (assembled in Step 308), the analyzer obtains a FRASP value for a transaction (e.g., the FRASP value (the target variable, see Step 324 of FIG. 3.2) refers to the value of an asset independent of the NPV of the in-place leases/CFs). A FRASP value may only be observed and known for assets that have transacted because market participants may determine this value through a market clearing process (e.g., a process about a transaction between a willing buyer and seller at some terms).

In Step 312, based on the FRASP value of the transaction (obtained in Step 310), the analyzer generates a FRASP dataset (see FIG. 5) from the augmented dataset.

Turning now to FIG. 3.2, the method shown in FIG. 3.2 may be executed by, for example, the above-discussed orchestrator, analyzer, and engine (e.g., 206, FIG. 2). Other components of the system (100) illustrated in FIG. 1 may also execute all or part of the method shown in FIG. 3.2 without departing from the scope of the invention.

In Step 314, in response to receiving the request (in Step 300 of FIG. 3.1), as part of that request, and/or in any other manner, the orchestrator obtains (or retrieves) an EDD from the demographics database (e.g., 124, FIG. 1). The orchestrator may then send the EDD to the analyzer. In one or more embodiments, the EDD may be obtained/accessed (for example, by querying the demographics database) to obtain data to be used in, at least, combining the FRASP dataset with the EDD, MD, ACD, and LD to generate a training dataset (see Step 322). Certain details of the EDD are described above in reference to FIG. 1.

In Step 316, in response to receiving the request (in Step 300 of FIG. 3.1), as part of that request, and/or in any other manner, the orchestrator obtains (or retrieves) an MD from the market information database (e.g., 125, FIG. 1). The orchestrator may then send the MD to the analyzer. In one or more embodiments, the MD may be obtained/accessed (for example, by querying the market information database) to obtain data to be used in, at least, combining the FRASP dataset with the EDD, MD, ACD, and LD to generate the training dataset. Certain details of the MD are described above in reference to FIG. 1.

In Step 318, in response to receiving the request (in Step 300 of FIG. 3.1), as part of that request, and/or in any other manner, the orchestrator obtains (or retrieves) an ACD from the assets' characteristics database (e.g., 126, FIG. 1). The orchestrator may then send the ACD to the analyzer. In one or more embodiments, the ACD may be obtained/accessed (for example, by querying the assets' characteristics database) to obtain data to be used in, at least, combining the FRASP dataset with the EDD, MD, ACD, and LD to generate the training dataset. Certain details of the ACD are described above in reference to FIG. 1.

In Step 320, in response to receiving the request (in Step 300 of FIG. 3.1), as part of that request, and/or in any other manner, the orchestrator obtains (or retrieves) an LD from the location information database (e.g., 128, FIG. 1). The orchestrator may then send the LD to the analyzer. In one or more embodiments, the LD may be obtained/accessed (for example, by querying the location information database) to obtain data to be used in, at least, combining the FRASP dataset with the EDD, MD, ACD, and LD to generate the training dataset. Certain details of the LD are described above in reference to FIG. 1.

In Step 322, the analyzer combines the FRASP dataset with the EDD, MD, ACD, and LD to generate the training dataset (see FIG. 6). Thereafter, the analyzer may store (temporarily or permanently) the training dataset in a storage/memory resource (of the IN (e.g., 200, FIG. 2)), in which the stored data may be used, for example, while generating (and/or training) an ML model (see Step 326).

In Step 324, the analyzer instructs the engine to generate a model (e.g., an ML model, a statistical model, a FRASP model, etc.) that predicts a “reasonable/fair” FRASP value for a transaction (as an optimization target based on, for example, asset quality, location-based factors, demographic and economic factors, etc.) and sends the training dataset to the engine (e.g., which is obtained from a large volume of actual closed transactions).

In Step 326, in response to receiving the instruction(s) from the analyzer (in Step 324), the engine generates a model and trains that model to obtain a “trained model”. In order to train the model (with little to no human interaction), the analyzer may use, at least, the training dataset. In one or more embodiments, the trained model may then be used for inferencing purposes (or for the “inferencing phase”, see FIG. 3.3).

For example, an asset that has not sold may have a theoretical fair FRASP value and the trained model may predict this value. The performance of the trained model may be evaluated when the asset is eventually sold.

In Step 328, after generating the trained model (in Step 326) (e.g., after a load-testing based training is completed and ready for inferencing), the engine initiates notification of an administrator/user (of the IN) about the generated “trained” model. The notification may include, for example (but not limited to): for what purpose the model has been trained, the amount of time that has been spent while performing the training process, etc.

In one or more embodiments, the notification may also indicate whether the training process was completed within the predetermined window, or whether the process was completed after exceeding the predetermined window. The notification may be displayed on a GUI of the IN. In one or more embodiments, the method may end following Step 328.

Turning now to FIG. 3.3, the method shown in FIG. 3.3 may be executed by, for example, the above-discussed orchestrator, analyzer, and engine. Other components of the system (100) illustrated in FIG. 1 may also execute all or part of the method shown in FIG. 3.3 without departing from the scope of the invention.

In Step 330, the orchestrator obtains (or retrieves) a VAD from the valuation information database (e.g., 129, FIG. 1). The orchestrator may then send the VAD to the analyzer. In one or more embodiments, the VAD may be obtained/accessed (for example, by querying the valuation information database) to obtain data to be used in, at least, combining the NPV of the known CF, WALE of the known lease, and VAD to generate a valuation dataset (see Step 332). Certain details of the VAD are described above in reference to FIG. 1.

In Step 332, upon receiving the VAD from the orchestrator (in Step 330), the analyzer combines/assembles the NPV of the known CF, WALE of the known lease, and VAD using the unique asset fingerprint to generate the valuation dataset (see FIG. 7). Thereafter, in Step 334, the analyzer combines/assembles the valuation dataset with the EDD, MD, ACD, and LD to generate an inferencing dataset (see FIG. 8).

In Step 336, the analyzer instructs the engine to infer a “reasonable” FRASP value for an asset valuation and sends the inferencing dataset to the engine. In Step 338, upon receiving the inferencing dataset and by employing the trained model (generated in Step 326 of FIG. 3.3), the engine infers the reasonable FRASP value for the asset valuation based on the inferencing dataset and sends the inferred/predicted reasonable FRASP value to the analyzer.

In Step 340, upon receiving the FRASP value of the asset, the analyzers appends the FRASP value to the inferencing dataset to generate an inferred “reasonable” FRASP value output. Thereafter, in Step 342, the analyzer generates a final asset valuation value output based on the inferred FRASP value of the asset and NPV of the known CF (e.g., the calculated assured income, by implementing a DCF model).

In Step 344, after obtaining the final asset valuation value for the asset, the analyzer initiates notification of the customer (that sent the request in Step 300 of FIG. 3.1) and the administrator of the IN about the final asset valuation value. The notification may include, for example, one or more technical details with respect to the final asset valuation value. In one or more embodiments, the notification may also indicate whether the inferring process was completed within the predetermined window, or whether the process was completed after exceeding the predetermined window. The notification may be displayed on the GUI of the IN (for the administrator) and on a GUI of the corresponding client (for the customer).

In one or more embodiments, upon inferring the final asset valuation value, the analyzer may store (temporarily or permanently) a copy of the final asset valuation value in the storage/memory resource of the IN. In one or more embodiments, the method may end following Step 344.

To further clarify embodiments of the invention, a non-limiting example use case is provided in FIGS. 4-10.

### Start of Example

The example use case, illustrated in FIGS. 4-10, is not intended to limit the scope of the embodiments disclosed herein and is independent from any other examples discussed in this application.

Turning now to FIG. 4, FIG. 4 shows a scenario in which upon combining the NPV of known CFs, WALE of the known leases, and STD using unique asset fingerprints, the analyzer generates an augmented dataset. For the sake of brevity, not all parameters of the augmented dataset may be discussed in FIG. 4.

Assume here that the augmented dataset shows: (a) for Transaction 1 (which is related to Asset 1): (i) the transaction ID (TID): 1, (ii) the unique asset fingerprint ID (AFID) or the asset ID: abc123, (iii) the NPV of a known CF for Asset 1: $25, (iv) the WALE of a known lease related to Asset 1:3 years, (v) the sale close date of Asset 1: Jan. 1, 2019, and (vi) the sale price (or sales price) of Asset 1: $103; (b) for Transaction 2 (which is related to Asset 2): (i) the TID: 2, (ii) the unique AFID: bcd234, (iii) the NPV of a known CF for Asset 2: $15, (iv) the WALE of a known lease related to Asset 2:5 years, (v) the sale close date of Asset 2: Feb. 15, 2019, and (vi) the sale price of Asset 2: $75; (c) for Transaction 3 (which is related to Asset 3): (i) the TID: 3, (ii) the unique AFID: cde345, (iii) the NPV of a known CF for Asset 3: $35, (iv) the WALE of a known lease related to Asset 3:7 years, (v) the sale close date of Asset 3: Jan. 1, 2017, and (vi) the sale price of Asset 3: $95; (d) for Transaction 4 (which is related to Asset 3): (i) the TID: 4, (ii) the unique AFID: cde345, (iii) the NPV of a known CF for Asset 3: $30, (iv) the WALE of a known lease related to Asset 3:5 years, (v) the sale close date of Asset 3: Mar. 2, 2022, and (vi) the sale price of Asset 3: $110; and (e) for Transaction 5 (which is related to Asset 2): (i) the TID: 5, (ii) the unique AFID: bcd234, (iii) the NPV of a known CF for Asset 2: $42, (iv) the WALE of a known lease related to Asset 2:1 year, (v) the sale close date of Asset 2: May 8, 2022, and (vi) the sale price of Asset 2: $137.

Turning now to FIG. 5, FIG. 5 shows a scenario in which upon obtaining a FRASP value for each transaction (refer to FIG. 4) and based on the augmented dataset, the analyzer generates a FRASP dataset. For the sake of brevity, not all parameters of the FRASP dataset may be discussed in FIG. 5.

Assume here that the FRASP dataset shows: (a) for Transaction 1 (which is related to Asset 1), the FRASP value: $78; (b) for Transaction 2 (which is related to Asset 2), the FRASP value: $60; (c) for Transaction 3 (which is related to Asset 3), the FRASP value: $60; (d) for Transaction 3 (which is related to Asset 3), the FRASP value: $80; and (e) for Transaction 2 (which is related to Asset 2), the FRASP value: $95.

Turning now to FIG. 6, FIG. 6 shows a scenario in which upon obtaining an EDD, MD, ACD, and LD from the orchestrator, the analyzer combines the FRASP dataset (refer to FIG. 5) with the EDD, MD, ACD, and LD to generate a training dataset. For the sake of brevity, not all parameters of the training dataset may be discussed in FIG. 6.

Assume here that the training dataset shows: (a) for Transaction 1 (which is related to Asset 1): (i) the population of a region where Asset 1 is located: 5,324, (ii) the average income of a tenant that lives in the region: $53,975, (iii) the age of Asset 1:10, (iv) Feature X1 (e.g., the number of apartment units in Asset 1) related to Asset 1: x11, (v) Feature X2 (e.g., the number of rooms in an apartment unit of Asset 1) related to Asset 1: x21, and (vi) Feature X (n) (e.g., the number of floors in an apartment unit of Asset 1) related to Asset 1: xn1; (b) for Transaction 2 (which is related to Asset 2): (i) the population of a region where Asset 2 is located: 4,398, (ii) the average income of a tenant that lives in the region: $82,753, (iii) the age of Asset 2:2, (iv) Feature X1 related to Asset 2: x12, (v) Feature X2 related to Asset 2: x22, and (vi) Feature X (n) related to Asset 2: xn2; (c) for Transaction 3 (which is related to Asset 3): (i) the population of a region where Asset 3 is located: 9,674, (ii) the average income of a tenant that lives in the region: $73,290, (iii) the age of Asset 3:3, (iv) Feature X1 related to Asset 3: x13, (v) Feature X2 related to Asset 3: x23, and (vi) Feature X (n) related to Asset 3: xn3; (d) for Transaction 4 (which is related to Asset 3): (i) the population of a region where Asset 3 is located: 9,932, (ii) the average income of a tenant that lives in the region: $77,938, (iii) the age of Asset 3:8, (iv) Feature X1 related to Asset 3: x14, (v) Feature X2 related to Asset 3: x24, and (vi) Feature X (n) related to Asset 3: xn4; and (e) for Transaction 5 (which is related to Asset 2): (i) the population of a region where Asset 2 is located: 10,329, (ii) the average income of a tenant that lives in the region: $48,476, (iii) the age of Asset 2:7, (iv) Feature X1 related to Asset 2: x15, (v) Feature X2 related to Asset 2: x25, and (vi) Feature X (n) related to Asset 2: xn5.

Thereafter, the analyzer instructs the engine to generate a model that predicts a FRASP value for each transaction and sends the training dataset. Upon receiving the training dataset, the engine generates a “trained” model using the training dataset.

Turning now to FIG. 7, FIG. 7 shows a scenario in which upon obtaining a VAD from the orchestrator, the analyzer combines the NPV of known CFs, WALE of known leases, and VAD using unique asset fingerprints to generate a valuation dataset. For the sake of brevity, not all parameters of the valuation dataset may be discussed in FIG. 7.

Assume here that the valuation dataset shows: (a) for Valuation 1 (which is related to Asset 1): (i) the valuation ID (VID): 1, (ii) the unique AFID: abc123, (iii) the NPV of a known CF for Asset 1: $25, (iv) the WALE of a known lease related to Asset 1:3 years, and (v) the valuation “as of” date of Asset 1: Jan. 1, 2019; (b) for Valuation 2 (which is related to Asset 2): (i) the VID: 2, (ii) the unique AFID: bcd234, (iii) the NPV of a known CF for Asset 2: $15, (iv) the WALE of a known lease related to Asset 2:5 years, and (v) the valuation “as of” date of Asset 2: Jan. 1, 2019; (c) for Valuation 3 (which is related to Asset 3): (i) the VID: 3, (ii) the unique AFID: cde345, (iii) the NPV of a known CF for Asset 3: $35, (iv) the WALE of a known lease related to Asset 3:7 years, and (v) the valuation “as of” date of Asset 3: Jan. 1, 2017; (d) for Valuation 4 (which is related to Asset 3): (i) the VID: 4, (ii) the unique AFID: cde345, (iii) the NPV of a known CF for Asset 3: $30, (iv) the WALE of a known lease related to Asset 3:5 years, and (v) the valuation “as of” date of Asset 3: Apr. 1, 2022; and (e) for Valuation 5 (which is related to Asset 2): (i) the VID: 5, (ii) the unique AFID: bcd234, (iii) the NPV of a known CF for Asset 2: $42, (iv) the WALE of a known lease related to Asset 2:1 year, and (v) the valuation “as of” date of Asset 2: Jul. 1, 2022.

Turning now to FIG. 8, FIG. 8 shows a scenario in which by combining the EDD, MD, ACD, and LD with the valuation dataset (refer to FIG. 7), the analyzer generates an inferencing dataset. For the sake of brevity, not all parameters of the inferencing dataset may be discussed in FIG. 8.

Assume here that the inferencing dataset shows: (a) for Valuation 1 (which is related to Asset 1): (i) the population of a region where Asset 1 is located: 5,324, (ii) the average income of a tenant that lives in the region: $53,975, (iii) the age of Asset 1:10, (iv) Feature X1 (e.g., the number of apartment units in Asset 1) related to Asset 1: x11, (v) Feature X2 (e.g., the number of rooms in an apartment unit of Asset 1) related to Asset 1: x21, and (vi) Feature X (n) (e.g., the number of floors in an apartment unit of Asset 1) related to Asset 1: xn1; (b) for Valuation 2 (which is related to Asset 2): (i) the population of a region where Asset 2 is located: 4,398, (ii) the average income of a tenant that lives in the region: $82,753, (iii) the age of Asset 2:2, (iv) Feature X1 related to Asset 2: x12, (v) Feature X2 related to Asset 2: x22, and (vi) Feature X (n) related to Asset 2: xn2; (c) for Valuation 3 (which is related to Asset 3): (i) the population of a region where Asset 3 is located: 9,674, (ii) the average income of a tenant that lives in the region: $73,290, (iii) the age of Asset 3:3, (iv) Feature X1 related to Asset 3: x13, (v) Feature X2 related to Asset 3: x23, and (vi) Feature X (n) related to Asset 3: xn3; (d) for Valuation 4 (which is related to Asset 3): (i) the population of a region where Asset 3 is located: 9,932, (ii) the average income of a tenant that lives in the region: $77,938, (iii) the age of Asset 3:8, (iv) Feature X1 related to Asset 3: x14, (v) Feature X2 related to Asset 3: x24, and (vi) Feature X (n) related to Asset 3: xn4; and (e) for Valuation 5 (which is related to Asset 2): (i) the population of a region where Asset 2 is located: 10,329, (ii) the average income of a tenant that lives in the region: $48,476, (iii) the age of Asset 2:7, (iv) Feature X1 related to Asset 2: x15, (v) Feature X2 related to Asset 2: x25, and (vi) Feature X (n) related to Asset 2: xn5.

Thereafter, the analyzer instructs the engine to infer a reasonable FRASP value for each asset valuation and sends the inferencing dataset. Upon receiving the inferencing dataset, the engine infers a reasonable FRASP value for each asset valuation based on the inferencing dataset and sends the inferred/predicted FRASP values to the analyzer.

Turning now to FIG. 9, FIG. 9 shows a scenario in which upon obtaining the inferred FRASP values from the engine, the analyzer appends the FRASP values to the inferencing dataset to generate an inferred reasonable FRASP value output for each asset valuation. For the sake of brevity, not all parameters of the corresponding FRASP value output dataset may be discussed in FIG. 9.

Assume here that the FRASP value output dataset shows: (a) for Valuation 1 (which is related to Asset 1), the inferred FRASP value: $83; (b) for Valuation 2 (which is related to Asset 2), the inferred FRASP value: $63; (c) for Valuation 3 (which is related to Asset 3), the inferred FRASP value: $55; (d) for Valuation 4 (which is related to Asset 3), the inferred FRASP value: $83; and (e) for Valuation 5 (which is related to Asset 2), the inferred FRASP value: $99.

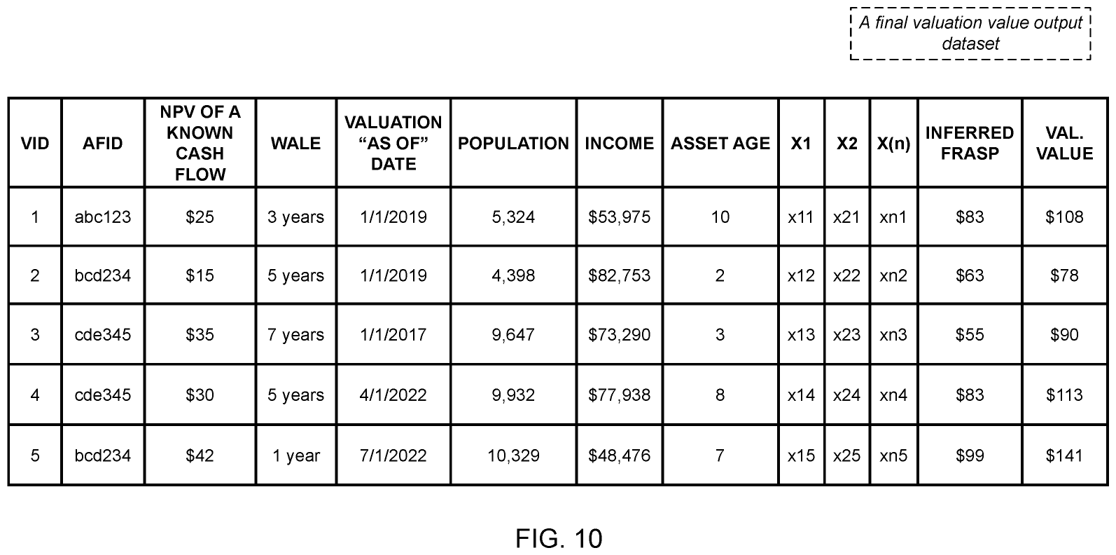

Turning now to FIG. 10, FIG. 10 shows a scenario in which based on the inferred FRASP value output dataset and NPV of known CFs, the analyzer generates a final valuation value output dataset (including, at least, a final asset valuation value for each asset). For the sake of brevity, not all parameters of the final valuation value output dataset may be discussed in FIG. 10.

Assume here that the final valuation value output dataset shows: (a) for Valuation 1 (which is related to Asset 1), the asset valuation value: $108; (b) for Valuation 2 (which is related to Asset 2), the asset valuation value: $78; (c) for Valuation 3 (which is related to Asset 3), the asset valuation value: $90; (d) for Valuation 4 (which is related to Asset 3), the asset valuation value: $113; and (e) for Valuation 5 (which is related to Asset 2), the asset valuation value: $141.

After obtaining the final asset valuation value for each asset, the analyzer initiates notification of the customer (via the GUI of the corresponding client) and the administrator (via the GUI of the IN) about the final asset valuation value for each asset.

### End of Example

Turning now to FIG. 11, FIG. 11 shows a diagram of a computing device in accordance with one or more embodiments of the invention.

In one or more embodiments of the invention, the computing device (1100) may include one or more computer processors (1102), non-persistent storage (1104) (e.g., volatile memory, such as RAM, cache memory), persistent storage (1106) (e.g., a non-transitory computer readable medium, a hard disk, an optical drive such as a CD drive or a DVD drive, a Flash memory, etc.), a communication interface (1112) (e.g., Bluetooth interface, infrared interface, network interface, optical interface, etc.), an input device(s) (1110), an output device(s) (1108), and numerous other elements (not shown) and functionalities. Each of these components is described below.

In one or more embodiments, the computer processor(s) (1102) may be an integrated circuit for processing instructions. For example, the computer processor(s) (1102) may be one or more cores or micro-cores of a processor. The computing device (1100) may also include one or more input devices (1110), such as a touchscreen, keyboard, mouse, microphone, touchpad, electronic pen, or any other type of input device. Further, the communication interface (1112) may include an integrated circuit for connecting the computing device (1100) to a network (e.g., a LAN, a WAN, Internet, mobile network, etc.) and/or to another device, such as another computing device.

In one or more embodiments, the computing device (1100) may include one or more output devices (1108), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1102), non-persistent storage (1104), and persistent storage (1106). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing valuations of real property assets, the method comprising:
obtaining, by an orchestrator, an asset dataset (AD);
analyzing, by an analyzer, the AD that is received from the orchestrator to generate a weighted average lease expiry (WALE) of a known lease and to generate a net present value (NPV) of a known cash flow;
obtaining, by the orchestrator, a sale transactions dataset (STD);
upon receiving the STD from the orchestrator, combining, by the analyzer, the NPV of the known cash flow, the WALE of the known lease, and the STD using a fingerprint to generate an augmented dataset;
obtaining, by the analyzer, a future rent and asset sale price (FRASP) value for a transaction based on the augmented dataset, wherein the FRASP value for the transaction is used to generate a FRASP dataset;
obtaining, by the orchestrator, an economic and demographic dataset (EDD), a market dataset (MD), an asset characteristics dataset (ACD), and a location dataset (LD);
combining, by the analyzer, the EDD, the MD, the ACD, and the LD that are received from the orchestrator with the FRASP dataset to generate a training dataset (TD), wherein an engine is instructed by the analyzer to generate a model that predicts FRASP values for transactions and wherein the TD is sent to the engine;
generating, after receiving the TD and by the engine, a trained model by training the model based on the TD;
inferring, by the engine and using the trained model, a FRASP value of a real property asset based on an inferencing dataset received from the analyzer,
wherein the real property asset is one selected from a group consisting of a commercial asset and a non-commercial asset;
upon receiving the FRASP value of the real property asset, appending, by the analyzer, the FRASP value of the real property asset to the inferencing dataset to generate an inferred FRASP value output;
generating, by the analyzer, an asset valuation value for the real property asset based on the FRASP value of the real property asset and the NPV of the known cash flow; and
initiating, by the analyzer, a display of the asset valuation value for the real property asset on a graphical user interface (GUI).

2. The method of claim 1, further comprising:
prior to inferring the FRASP value of the real property asset:
obtaining, by the orchestrator, a valuation asset dataset (VAD), wherein the VAD is sent to the analyzer;
combining, by the analyzer, the NPV of the known cash flow, the WALE of the known lease, and the VAD using the fingerprint to generate a valuation dataset; and
combining, by the analyzer, the valuation dataset with the EDD, the MD, the ACD, and the LD to generate the inferencing dataset.

3. The method of claim 1, wherein generating the trained model further comprises:
prior to training the model, selecting, by the engine, the model from a plurality of models; and
selecting, by the engine, a first feature and a second feature that are considered by the model while generating the trained model,
wherein the first feature specifies at least one selected from a group consisting of a population of an area, an average income of a person living in the area, and an age of the asset, and
wherein the second feature specifies at least one selected from a group consisting of information in relation to supply net absorption, information in relation to an asking rent, and information in relation to a location.

4. The method of claim 3, wherein, in order to select the model, mean absolute percentage error score and root mean squared error score associated with each of the plurality of models are calculated.

5. The method of claim 3, wherein while the first feature and the second feature are selected, a recursive feature elimination model is used.

6. The method of claim 1, wherein the fingerprint is an identifier that specifies a parcel associated with a location address of the real property asset, wherein the fingerprint is obtained by the orchestrator in response to sending the location address of the asset to a mapping server.

7. The method of claim 6, wherein the fingerprint is determined using a knowledge graph.

8. The method of claim 1, wherein the AD specifies at least one selected from a group consisting of information in relation to an in-place lease document, information in relation to a rent roll, information in relation to a lease expiry date and time, information in relation to a lease renewal option, information in relation to a tenant improvement, information in relation to a free rent period, information in relation to a known operating expense, and information in relation to known capital expenditure.

9. The method of claim 8, wherein the known capital expenditure comprises at least one selected from a group consisting of a fee to replace an asset's roof, a fee to replace an asset-wide air conditioning system, and a fee to implement a newer asset automation system.

10. The method of claim 8, wherein the known operating expense comprises at least one selected from a group consisting of a landscaping fee, a pest control fee, a utility fee, and an insurance fee.

11. The method of claim 1, wherein the STD specifies at least one selected from a group consisting of information in relation to a location, information in relation to a type of a sale event, information in relation to a sale price of a second asset, and information in relation to a close date of a sale event.

12. The method of claim 1, wherein the EDD specifies at least one selected from a group consisting of a population of an area, an average income of a person living in the area, a type of an employment available in the area, and information in relation to a migration pattern.

13. The method of claim 1, wherein the MD specifies at least one selected from a group consisting of information in relation to a vacancy status of a second asset, information in relation to an existing supply, information in relation to supply net absorption, and information in relation to an asking rent.

14. The method of claim 1, wherein the ACD specifies at least one selected from a group consisting of an age of a second asset, a health condition of the second asset, a size of the second asset, a size of a lot that hosts the second asset.

15. A method for managing valuation of an asset, the method comprising:
obtaining, by an orchestrator, an asset dataset (AD);
analyzing, by an analyzer, the AD that is received from the orchestrator to generate a weighted average lease expiry (WALE) of a known lease and to generate a net present value (NPV) of a known cash flow;
obtaining, by the orchestrator, a sale transactions dataset (STD);
upon receiving the STD from the orchestrator, combining, by the analyzer, the NPV of the known cash flow, the WALE of the known lease, and the STD using a fingerprint to generate an augmented dataset;
obtaining, by the analyzer, a future rent and asset sale price (FRASP) value for a transaction based on the augmented dataset, wherein the FRASP value for the transaction is used to generate a FRASP dataset;
obtaining, by the orchestrator, an economic and demographic dataset (EDD), a market dataset (MD), an asset characteristics dataset (ACD), and a location dataset (LD);
combining, by the analyzer, the EDD, the MD, the ACD, and the LD that are received from the orchestrator with the FRASP dataset to generate a training dataset (TD), wherein an engine is instructed by the analyzer to generate a model that predicts FRASP values for transactions and wherein the TD is sent to the engine;
generating, by the engine, a trained model by training the model based on the TD; and
initiating, by the engine, notification of an administrator about the trained model using a graphical user interface (GUI).

16. The method of claim 15, further comprising:
after the notification of the administrator:
inferring, by the engine and using the trained model, a FRASP value of the asset based on an inferencing dataset received from the analyzer;
upon receiving the FRASP value of the asset, appending, by the analyzer, the FRASP value to the inferencing dataset to generate an inferred FRASP value output;
generating, by the analyzer, an asset valuation value for the asset based on the FRASP value of the asset and the NPV of the known cash flow; and
initiating, by the analyzer, notification of the administrator about the asset valuation value for the asset using the GUI.

17. The method of claim 16, further comprising:
prior to inferring the FRASP value of the asset:
obtaining, by the orchestrator, a valuation asset dataset (VAD), wherein the VAD is sent to the analyzer;
combining, by the analyzer, the NPV of the known cash flow, the WALE of the known lease, and the VAD using the fingerprint to generate a valuation dataset; and
combining, by the analyzer, the valuation dataset with the EDD, the MD, the ACD, and the LD to generate the inferencing dataset.

18. The method of claim 15, wherein generating the trained model further comprises:
prior to training the model, selecting, by the engine, the model from a plurality of models; and
selecting, by the engine, a first feature and a second feature that are considered by the model while generating the trained model,
wherein the first feature specifies at least one selected from a group consisting of a population of an area, an average income of a person living in the area, and an age of the asset, and
wherein the second feature specifies at least one selected from a group consisting of information in relation to supply net absorption, information in relation to an asking rent, and information in relation to a location.

19. The method of claim 15, wherein the fingerprint is an identifier that specifies a parcel associated with a location address of the asset, wherein the fingerprint is obtained by the orchestrator in response to sending the location address of the asset to a mapping server.

20. A method for managing valuation of an asset, the method comprising:
inferring, by an engine and using a trained model, a future rent and asset sale price (FRASP) value of an asset based on an inferencing dataset received from an analyzer;
upon receiving the FRASP value, appending, by the analyzer, the FRASP value to the inferencing dataset to generate an inferred FRASP value output;
generating, by the analyzer, an asset valuation value for the asset based on the FRASP value and a net present value (NPV) of a known cash flow; and
initiating, by the analyzer, notification of an administrator about the asset valuation value for the asset using a graphical user interface (GUI).
